(19) United States
(12) Patent Application Publication
(10) Pub. No.: US 2024/0005173 A1
(43) Pub. Date: Jan. 4, 2024

(54) Verifying Neural Networks

(71) Applicant: IMPERIAL COLLEGE INNOVATIONS LIMITED, London (GB)

(72) Inventors: Alessio LOMUSCIO, London (GB); Patrick HENRIKSEN, London (GB); Panagiotis KOUVAROS, London (GB)

(21) Appl. No.: 18/039,997

(22) PCT Filed: Dec. 2, 2021
(86) PCT No.: PCT/EP2021/084042

§ 371 Date: Jun. 2, 2023

(30) Foreign Application Priority Data
Dec. 2, 2020 (GB) 2019034.4

(51) Int. Cl. G06N 3/10; G06N 3/048

(52) U.S. Cl. CPC G06N 3/10; G06N 3/048

(57) ABSTRACT

Systems and methods are provided for verifying the transformational robustness of a neural network. Data is obtained representing a trained neural network, a set of algebraic constraints on the output of the network, and a range of inputs to the neural network over which the algebraic constraints are to be verified, such that the data defines a transformational robustness verification problem. A set of complementary constrains on the pre-activation of a node in the network are then determined such that for any input in the range of inputs, at least one of the complementary constraints is satisfied. A plurality of child verification problems are generated based on the transformational robustness verification problem and the set of complementary constraints. For each child verification problem, it is determined whether a counter-example to the child verification problem exists. Based on the determination of whether counter-examples to the child verification problems exist, it is determined whether the neural network is transformationally robust.

### BACKGROUND

Autonomous systems are forecasted to revolutionise key aspects of modern life including mobility, logistics, and beyond. While considerable progress has been made on the underlying technology, severe concerns remain about the safety and security of the autonomous systems under development.

One of the difficulties with forthcoming autonomous systems is that they incorporate complex components that are not programmed by engineers but are synthesised from data via machine learning methods, such as a neural network. Neural networks have been shown to be particularly sensitive to variations in their input. For example, neural networks currently used for image processing have been shown to be vulnerable to adversarial attacks in which the behaviour of a neural network can easily be manipulated by a minor change to its input, for example by presenting an “adversarial patch” to a small portion of the field of view of the image. At the same time, there is an increasing trend to deploy autonomous systems comprising neural networks in safety-critical areas, such as autonomous vehicles. These two aspects taken together call for the development of rigorous methods to systematically verify the conformance of autonomous systems based on learning-enabled components to a defined specification. Often, such a specification can be defined in terms of robustness to one or more transformations at one or more inputs—formally, a network is said to be transformationally robust at a given input under a class of transformations if its output remains within a specified tolerance (e.g. one small enough to not cause a change in predicted class) when the input is subjected to any transformation in the class. For example, safeguards on acceptable behaviour of the ACAS XU unmanned aircraft collision avoidance system have been defined in terms which are equivalent to transformational robustness (in K. Julian, J. Lopez, J. Brush. M. Owen and M. Kochenderfer. Policy compression for aircraft collision avoidance systems. In Proceedings of the 35th Digital Avionics Systems Conference (DASC16), pages 1-10, 2016). In other examples, acceptable behaviour of image classifiers has been specified in terms of continuing to predict the same class when a particular image input is subjected to transformations which remain within a certain Lp-distance, or subjected to a certain class of affine and/or photometric transformations.

In general, techniques for verifying a neural network's transformational robustness operate by decomposing the given transformational robustness verification problem into a plurality of complementary child verification problems, where each child verification problem is the original verification problem augmented with a set of one or more additional constraints. The child verification problems complement one another in the sense that for any transformation of the neural network input in the class, at least one of the sets of additional constraints is always satisfied. Those child verification problems for which it can be determined that no counter-example exists can then be discarded, while child verification problems which might admit a counter-example can themselves be recursively decomposed into further child verification problems, until either all child verification problems are discarded—in which case the transformational robustness property is proven—or the search space for counter-examples is reduced sufficiently for a counter-example to be easily found, in which case the transformational robustness property is disproven. The benefit of these decompositional approaches is that gradual progress can be made towards solving the transformational robustness problem by restricting (or altogether eliminating) the space wherein counter-examples must lie as more and more additional constraints are determined that would need to be satisfied by any counter-examples. However, while these techniques are effective on small models, the number of child verification problems that need to be solved for meaningful progress to be made increases greatly with the complexity of the neural network. As such, when attempting to verify the large networks currently used in vision and other complex tasks, the verification process often terminates inconclusively for lack of computational resources.

For example, a transformational robustness verification problem can be encoded into a problem of finding a solution a set of algebraic constraints where some of the variables are constrained to be binary (such as a Mixed-Integer Linear Program), as described in International Patent Publication WO 2020/109774 A1. A solution to the set of algebraic constraints can then be searched for using branch-and-bound techniques, as described in “Optimization in Operations Research”. Ronald L. Rardin, Prentice-Hall, 1998, ISBN 0-02-398415-5, chapter 12. Such branch-and-bound techniques start by attempting to find a solution to a relaxation of the set of algebraic constraints, where the binary constraints are relaxed into linear inequality constraints (e.g., x∈[0;1] is relaxed to x≥0 and x≤1). If the relaxed set of algebraic constraints admits no solution, then transformational robustness is proven; otherwise, two child verification problems are constructed by fixing one of the binary variables to the value 0 in one child problem, and the value 1 in the other. The solver then attempts to find a solution to each child verification problem: if it admits no solution, it is discarded, and if it does admit a solution, then it is itself split into two child verification problems by fixing the value of another binary variable. This process can be performed recursively, such that each child verification problem which does admit a solution is split into two child verification problems, until either all child verification problems are discarded, or a child verification problem is solved where all binary variables have had their values fixed, yielding a counter-example to the original transformational robustness problem. At each iteration, the binary variable to be fixed is typically chosen either at random or using a default heuristic (e.g., the variable whose relaxed solution is closest to 0.5). However, the worst-case number of child verification problems which may need to be evaluated is on the order of 2^{N} where N is the number of binary variables, which typically scales linearly with the number of nodes in the network, such that on large networks such branch-and-bound techniques often cannot produce a conclusive result for lack of computational resources.

As another example, interval propagation techniques such as Symbolic Interval Propagation (SIP) (described in S. Wang, K. Pei, J. Whitehouse, J. Yang, and S. Jana. Efficient formal safety analysis of neural networks. In Proceedings of the 27^{th} USENIX Security Symposium, (USENIX18), pages 1599-1614, 2018) derive bounds on the pre-activations and outputs of the nodes of the network given bounds on the network's inputs, and in this way obtain bounds on the network's output. Because these techniques are approximate, applying them directly usually produces an inconclusive result, in that transformational robustness cannot usually be proven, but neither can a space in which counter-examples lie be identified with enough precision to obtain a counter-example. In an effort to obtain a conclusive result, the original problem may then be decomposed into several child verification problems—in particular, by partitioning the space of possible inputs into multiple cases and evaluating the transformational robustness property on each case using the interval propagation technique. However, while this approach enables tighter bounds to be obtained on the neural network's outputs, the number of child verification problems to consider also becomes prohibitively large as the neural network becomes large, such that these techniques also often yield inconclusive results for lack of computational resources.

### SUMMARY

According to a first aspect, there is provided a method for verifying the transformational robustness of a neural network. The method comprises: obtaining data representing a trained neural network, a set of algebraic constraints on the output of the network, and a range of inputs to the neural network over which the algebraic constraints are to be verified, such that the data defines a transformational robustness verification problem; determining a set of complementary constraints on the pre-activation of a node in the network such that for any input in the range of inputs, at least one of the complementary constraints is satisfied; generating a plurality of child verification problems based on the transformational robustness verification problem and the set of complementary constraints; determining, for each child verification problem, whether a counter-example to the child verification problem exists; and based on the determination of whether counter-examples to the child verification problems exist, determining whether the neural network is transformationally robust.

Beneficially, such a method may be capable of providing a definite (i.e. mathematically correct) finding as to whether a neural network is transformationally robust to an entire class of transformations, while at the same time using fewer computational operations than other methods which can provide such guarantees, particularly on large networks. As such, the disclosed method may enable a finding of robustness to be obtained for networks previously too large to be verified.

Verifying whether a neural network is transformationally robust may be useful in view of deploying the network as part of an autonomous or semi-autonomous system, where the outputs of the neural network are used either to automatically drive actions of the system or to inform further human or machine decision-making. Indeed, such a verification may make it possible to evaluate the extent to which a network conforms to specified behaviour, and therefore the extent to which its outputs may be considered reliable. Moreover, networks too prone to error or too vulnerable to adversarial attacks may be identified and rejected before the safety and/or security of the system is compromised.

These benefits are particularly important in the context of safety-critical perception systems. For example, the neural network may operate as part of a perception system comprising a classifier configured to classify sensor data such as image data and/or audio data and a controller configured to take one or more actions in dependence on the output of the classifier. The perception system may further comprise an actuator configured to operate in accordance with control signals received from the controller. In such circumstances, whether the neural network forms part of the classifier or of the controller, the reliability of these actions may be compromised when the neural network does not behave according to a specified behaviour.

Moreover, the method may enable the construction of a counterexample which can be used as evidence in safety-critical analysis. Such an example can also be used to augment the dataset and retrain the neural network to improve its robustness.

Optionally, at least two constraints of the complementary constraints may constrain the pre-activation of the node to be respectively less than and greater than a threshold pre-activation value at which the activation function of the node has a breakpoint.

Optionally, one or more nodes of the neural network may apply a Rectified Linear Unit (ReLU) activation function, and the complementary constraints may be constraints on the pre-activation of a ReLU node.

Optionally, determining the set of complementary constraints on the pre-activation of a node in the network may comprise estimating, for each of a plurality of candidate node pre-activation constraints, a reduction in complexity of the transformational robustness verification problem occasioned by introducing the constraint; and selecting, based on the estimated reductions in complexity, a set of two or more complementary constraints.

Optionally, estimating, for a candidate node pre-activation constraint, a reduction in complexity of the transformational robustness verification problem occasioned by introducing the constraint may comprise estimating a reduction in the estimated ranges of the pre-activations of other nodes occasioned by introducing the candidate node pre-activation constraint; and estimating, based on the estimated reductions in estimated ranges of pre-activations of other nodes, an estimated reduction in complexity of the transformational robustness verification problem.

Optionally, estimating, for a candidate node pre-activation constraint, a reduction in the estimated ranges of the pre-activations of other nodes occasioned by introducing the candidate node pre-activation constraint, may comprise determining, for each node in the network, a symbolic expression in terms of the input to the neural network that is a lower bound to the pre-activation of the node, and a symbolic expression in terms of the input to the neural network that is an upper bound to the pre-activation of the node; and estimating the reduction in the estimated ranges of the pre-activations of other nodes based on the lower and upper symbolic bounds.

Optionally, the lower and the upper symbolic bounds may both be linear functions of the input to the neural network; and determining the lower and upper symbolic bounds may comprise performing a Symbolic Interval Propagation.

Optionally, determining, for each child verification problem, whether a counter-example to the child verification problem exists may comprise encoding the child verification problem as a set of algebraic constraints and solving for a solution to the set of algebraic constraints using a branch-and-bound algorithm. Estimating, based on the estimated reductions in estimated ranges of pre-activations of other nodes, an estimated reduction in complexity of the transformational robustness verification problem occasioned by introducing a candidate node pre-activation constraint may comprise determining a number of nodes whose pre-activations would be constrained to be fully positive or fully negative over the entire range of inputs to the network were the candidate node pre-activation constraint to be introduced.

Optionally, determining, for each child verification problem, whether a counter-example to the child verification problem exists may comprise determining, for each node in the network, a symbolic expression in terms of the input to the neural network that is a lower bound to the pre-activation of the node, and a symbolic expression in terms of the input to the neural network that is an upper bound to the pre-activation of the node; determining, based on the lower and upper symbolic bounds, a lower and an upper bound for each component of the output of the network; and determining, based on the lower and upper bounds, whether a counter-example to the child verification problem exists. Estimating, based on the estimated reductions in estimated ranges of pre-activations of other nodes, an estimated reduction in complexity of the transformational robustness verification problem occasioned by introducing a candidate node pre-activation constraint may comprise determining an estimated improvement in the lower and upper bounds for each component of the output of the network were the candidate node pre-activation constraint to be introduced.

In some example implementations, the neural network may be an image processing network which takes an image as input. For example, the neural network may be trained for an image classification, object detection, image reconstruction, or other image processing task. In such implementations, if the neural network is determined to be transformationally robust, the network may further be deployed for performing the image processing task, such as the image classification, object detection or image reconstruction task. In particular, if the neural network is determined to be transformationally robust, the network may perform the image processing task (such as image classification) on an image. In such circumstances, it may be possible to provide guarantees on the appropriateness of the network to perform the image processing task correctly.

In other example implementations, the neural network may be an audio processing network which takes a representation of an audio signal as input. For example, the neural network may be trained for a voice authentication, speech recognition, audio reconstruction, or other audio processing task. In such implementations, if the neural network is determined to be transformationally robust, the network may further be deployed for performing the audio processing task, such as the voice authentication, speech recognition or audio reconstruction task. In particular, if the neural network is determined to be transformationally robust, the network may perform the audio processing task. In such circumstances, it may be possible to provide guarantees on the appropriateness of the network to perform the audio processing task correctly.

While the above example implementations refer to image processing or audio processing, the skilled person will recognised that the claimed approach may apply to other inputs; for example, the input to the neural network may be sensor data such as image data, audio data, LiDAR data, or other data. In general, the claimed process may act to improve the ability or reliability of a network in classifying data of this kind.

In other example implementations, the neural network may be part of an AI system to evaluate the credit worthiness or other risk or financial metrics and takes as input the relevant tabular information used to assess a financial decision. For example, the neural network may be trained for credit scoring of applicants for loan purposes. In such implementations, if the neural network is determined to be transformationally robust, the network may further be deployed for the decision making task in question. In particular, if the neural network is determined to be transformationally robust, guarantees may be given to the relevant regulators on the appropriateness of the network to perform the audio processing task correctly.

In yet other example implementations, the neural network may be a controller neural network which outputs a control signal for a physical device, such as an actuator. For example, the neural network may be trained for controlling a robot, vehicle, aircraft or plant. In such implementations, if the neural network is determined to be transformationally robust, the network may further be deployed for controlling the physical device, such as the actuator, robot, vehicle, aircraft or plant. In particular, if the neural network is determined to be transformationally robust, the network may control the physical device.

Other applications of the method above are in fraud monitoring, medical imaging, optical character recognition and generally whenever guarantees of transformational robustness aid in determining the robustness of the neural model.

According to a further aspect, there may be provided a computer program product comprising computer executable instructions which, when executed by one or more processors, cause the one or more processors to carry out the method of the first aspect.

There may also be provided an implementation comprising one or more processors configured to carry out the method of the first aspect.

### BRIEF DESCRIPTION OF THE DRAWINGS

FIG. 1 shows an example method for verifying the transformational robustness of a neural network.

FIG. 2 depicts an example neural network.

FIG. 3 depicts an example input and example transformations for which a transformational robustness property might be evaluated.

FIG. 4 shows a Symbolic Interval Propagation process.

FIG. 5 depicts a lower and an upper linear function bound on an activation function.

FIG. 6 shows a first example method for determining one or more complementary node pre-activation constraints which reduce the complexity of the verification problem.

FIG. 7 depicts the dependencies between node state constraints for the neural network of FIG. 2.

FIG. 8 shows a second example method for determining one or more complementary node pre-activation constraints which reduce the complexity of the verification problem.

FIG. 9 shows an example method for solving a child verification problem.

FIG. 10 shows another example method for solving a child verification problem.

FIG. 11 shows an improved Symbolic Interval Propagation process.

FIG. 12 illustrates an example system capable of verifying the transformational robustness of a neural network.

### DETAILED DESCRIPTION

The present disclosure is directed to the verification of a neural network's transformational robustness, that is, a guarantee that its outputs remain within a certain tolerance when a starting input to the neural network input is subjected to a class of transformations.

The present disclosure extends decompositional techniques, which recursively construct child verification problems from an original transformational robustness problem by introducing additional constraints, in an effort to improve the speed of verification, that is, the time needed in order to obtain a definite finding of transformational robustness or a counter-example. The present disclosure achieves this by guiding the selection of the additional constraints so as to purposefully reduce the complexity of the resulting child verification problems and therefore make more effective progress towards solving the transformational robustness verification problem at each decomposition, in contrast to prior approaches which select the additional constraints either at random, or using default heuristics from a solver. As shown in the accompanying results, this enables the transformational robustness property to be proven and/or disproven using fewer computational resources compared to previous approaches, and enables the verification of transformational robustness for networks previously too large to be verified.

The additional constraints introduced into a verification problem in the context of the present disclosure can in principle be of any form. Thus while the child verification problems are “verification problems” in the sense that they define a mathematical property to be numerically verified, they do not necessarily themselves directly correspond to a neural network.

Advantageously, the additional constraints introduced in the context of the present disclosure may be constraints that constrain the pre-activation of a node to a certain range. For example, given a neural network N with nodes n_{j,u}(n_{j,u} being the u-th node of the j-th layer of the neural network), the problem of determining whether N is robust to a set of transformations T at an input x₀ may be decomposed into the two child problems (1) determining whether N is robust to T at x assuming that the activation \hat{x}_{i,v} of a particular node n_{i,v} is greater than or equal to a threshold value t_{i,v}, and (2) determining whether N is robust to T at x₀ assuming that the pre-activation \hat{x}_{i,v} is less than or equal to the threshold value t_{i,v}. By solving both child problems, a solution is found to the original problem: if both of the child problems lead to a finding of robustness, the original transformational robustness property is proven, otherwise, it is disproven. By judiciously choosing the node n_{i,v} and the threshold value t_{i,v}, the resulting child problems can be made much simpler to solve than the original problem, as will be explained below. Such a technique may also be applied iteratively by decomposing each child problem into further child problems, with compounding benefits.

The reason why child problems obtained by introducing such node pre-activation constraints may be easier to solve than the original problem is because introducing a constraint on the range of a node n_{i,v}'s pre-activation \hat{x}_{i,v} can enable an interval bounding technique such as Symbol Interval Propagation to derive tighter (i.e. more precise) symbolic constraints for the pre-activations and outputs of nodes in the network. These symbolic constraints are expressions in terms of the neural network's input, which provide a lower and/or upper bound on a pre-activation or an output of a node in the network.

In particular, tighter symbolic constraints can be derived for the pre-activations of other nodes n_{i,u} in the same layer as n_{i,v}, because the constraint on n_{i,v}'s pre-activation \hat{x}_{i,v} induces a constraint on n_{i,v}'s inputs, which are also n_{i,u}'s inputs. Furthermore, tighter symbolic constraints can be derived for the pre-activations of nodes n_{i+1,u} in the layer following n_{i,v}, because the constraint on n_{i,v}'s pre-activation \hat{x}_{i,v} induces a constraint on n_{i,v}'s output x_{i,v}, which is an input of n_{i+1,u}, so that tighter symbolic constraints can be derived for the pre-activation \hat{x}_{i+1,u} of node n_{i+1,u}. In turn, this can enable tighter symbolic constraints to be derived for the pre-activations of nodes n_{i+2,t} in the layer after that, and so forth.

Thus, judiciously choosing a first constraint can lead to a cascade of further constraints being inferred. All these additional constraints may strengthen the verification problem, because they introduce additional constraints without introducing new variables. Depending on the strength of the additional symbolic constraints, their presence can speed up the solving algorithm, as a result of rendering the child verification problem more tightly constrained than the original one.

Advantageously, the additional constraints to introduce into child verification problems may be selected by evaluating a plurality of candidate additional constraints for their effect on reducing the complexity of the verification problem, and selecting one or more of the candidate additional constraints for constructing child verification problems. In particular, the effect which a node pre-activation constraint would have on the complexity of the verification problem may be estimated by predicting how introducing the node pre-activation constraint would reduce predicted numerical ranges of the pre-activations of other nodes in the network. Intuitively, to reduce predicted numerical ranges of pre-activations of nodes will reduce the complexity of the verification problem, by enabling the search for a counter-example to the transformational robustness property to be conducted in a smaller space, such that the existence of a counter-example can be determined more efficiently.

Further advantageously, the reductions in the numerical ranges of node pre-activations may be determined from lower and upper symbolic bounds on the pre-activations and outputs of the nodes in the neural network, which are expressions in terms of the input to the neural network. Such lower and upper symbolic bounds on the pre-activations and outputs of nodes, in terms of the neural network's input, may enable the effect of introducing a new node pre-activation constraint on the predicted numerical ranges of the pre-activations of other nodes vary to be efficiently and precisely ascertained, thereby enabling the evaluation of candidate additional constraints to proceed in a computationally efficient way.

More specifically, the effects of introducing a candidate node pre-activation constraint on the complexity of the resulting child verification problem may be evaluated with respect to one or more of the following effects.

Before explaining the effects, some nomenclature is first introduced. A neural network consists of nodes organised in a sequence of layers. Each node defines a function that applies to its inputs a weighted linear combination, followed by a non-linear function such as a Rectified Linear Unit (ReLU), sigmoid, or tanh function. The result of the weighted linear combination is called the node's “pre-activation”, and the non-linear function is called the node's “activation function”. Typically, the nodes in the final layer of the neural network do not apply an activation function, such that the output of the neural network can be taken to be the concatenation of pre-activations of the nodes in the final layer. In addition, each node is said either to be in the “active” or in the “inactive” state, depending on the value of its pre-activation: an “active” node has a pre-activation greater than a pre-determined threshold pre-activation value which depends on the particular activation function used by the node, whereas an “inactive” node has a pre-activation less than the threshold pre-activation value. For example, the threshold pre-activation value may be a value at which the activation function has a breakpoint. In particular, the activation function may be piece-wise linear, and the threshold activation value may be the intersection of two linear segments of the activation function. More particularly, the activation function may be a ReLU and the threshold activation value may be equal to zero. Furthermore, given a particular input to the network and a class of transformations to check for robustness against, some of the nodes are said to be “stable” in that they either remain in the active or in the inactive state over all the transformations in the class. The other nodes are said to be “unstable” in that they are active state for some transformations in the class and inactive for other transformations. The greater the perturbations introduced by the transformations to be applied to the input, the greater the number of unstable nodes. Finally, a “node state constraint” is a node pre-activation constraint which constrains a node's pre-activation to be greater than or less than the threshold pre-activation value for the node's activation function, that is, which constrains the node to be active or to be inactive. In particular, where a node's activation function is a ReLU, a node pre-activation constraint for the node may constrain the node's pre-activation to be greater than or less than zero.

As a first effect, when introducing a node state constraint, the number of integer variables appearing in the encoding of the resulting child verification problem as a set of algebraic constraints may be reduced, which in turn reduces the complexity of determining the existence of a solution to the set of algebraic constraints. This effect may for example demonstrate itself when the nodes of the network use a piecewise linear activation function such as the ReLU activation function. Indeed, when encoding a verification problem as a set of algebraic constraints, each unstable ReLU node typically requires one binary variable to represent, that is, a variable whose value is constrained to be 0 or 1. Although there is no easily-defined measurement of the “difficulty” of finding a solution to a set of algebraic constraints with some variables constrained to be binary (as for most numerical optimization problems), it is generally true that the number of operations taken by algorithms for solving such problems (such as the branch-and-bound algorithm for Mixed-Integer Linear Programs) increases significantly with the number of binary variables. As such, because the difficulty of the verification problem scales with the number of unstable ReLU nodes, each node state constraint, which constrains an unstable node to be either active or inactive, reduces the difficulty of the verification problem.

Introducing a node state constraint always reduces the number of unstable nodes in the resulting child verification problem by at least one, but beneficially, introducing a node state constraint may also induce further node state constraints, each of which also reduces the number of unstable nodes in the child verification problem by one. This is because constraining a node's pre-activation to be positive (or negative) may reduce the operating range of other nodes' pre-activations to be wholly positive or negative. The further node state constraints may be inferred in one or more of the following ways. Firstly, further node state constraints may be inferred for other nodes in the same layer as the node, which share the same inputs as the node and whose pre-activations therefore correlate to some degree with the pre-activation of the node. Secondly, further node state constraints may be inferred for nodes in subsequent layers, whose pre-activations are influenced by the node's output and are therefore influenced by the pre-activation of the node. Of course, it will be apparent to the skilled reader that the number of further node state constraints that can thus be inferred may greatly vary between different candidate node state constraints which could be introduced. Nevertheless, in a large neural network, there are likely to be at least some nodes for which introducing a node state constraint will enable many further node state constraints to be inferred, thus significantly reducing the difficulty of the ensuing child verification problems.

For this reason, in order to choose a node to which to apply a first node state constraint, it may be desirable to know the number of additional node state constraints which could be inferred from the first constraint. To achieve this, for each node state constraint which might possibly be introduced, it may be determined which (if any) further node state constraints would be induced: these further node state constraints are then said to “depend” on the first node state constraint. Knowing the dependencies between node state constraints may then enable a pair of complementary node state constraints to be optimally chosen in order to construct a pair of child verification problems. In particular, the pair of complementary node state constraints which between them enable the maximum number of further node state constraints to be induced may be chosen.

A second effect of introducing a node state constraint comes in the context of the Symbolic Interval Propagation (SIP) technique for the verification of neural networks.

The SIP technique consists in approximating each activation function in a neural network by a lower and an upper linear function bound. Consequently, the range of the neural network inputs corresponding to the class of transformations to verify may be substituted into these linear function bounds in order to obtain concrete bounding intervals for the neural network outputs.

The resulting bounding intervals will necessarily be larger than the range of network outputs actually induced by the range of network inputs to verify, because of the approximative nature of the lower and upper function bounds obtained for each node. Specifically, for the ReLU activation function, the error introduced by the lower and upper linear function bounds typically depends on the function's input domain: if the domain is purely positive or purely negative, the ReLU function is purely a linear function and therefore the lower and upper linear function bounds are exact. However, if the domain is partly positive and partly negative, the lower and upper linear function bounds will not be exact, with the approximation error increasing as the domain grows on both sides of zero. Therefore, constraining the pre-activation of a node to be positive or to be negative eliminates this approximation error and therefore improves the tightness of the output bound obtained by SIP. The greater the activation function's input domain on both sides of zero, the greater the reduction in approximation error obtained by introducing the constraint.

A third effect of introducing a node pre-activation constraint also manifests itself when applying Symbolic Interval Propagation. Indeed, not only is the approximation error introduced by the lower and upper linear function bounds eliminated for the constrained node, as explained above, but as a result of these bounds becoming exact, the lower and upper linear function bounds of succeeding nodes can also be made tighter, which also improves the tightness of the output bound obtained by SIP.

Therefore, by calculating the reduction in approximation error which would result from the second and third effect if a positivity/negativity constraint were to be applied a node, a node to constrain may be optimally selected, so as to reduce the SIP approximation error and therefore provide a tighter bounding interval for the network's outputs.

Each child verification problem can then each be solved using techniques such as by encoding into a set of algebraic constraints and finding a solution to the set of constraints, or by Symbolic Interval Propagation (SIP). Advantageously, the child verification problem may be solved using a new Symbolic Interval Propagation technique which enables even tighter bounds on the outputs of the network to be obtained. By judiciously choosing the additional constraints, the combined execution time of calculating the decomposition and solving the child problems may be reduced compared to solving the original problem, which may enable robustness guarantees to be obtained for networks too complex for previous verification techniques.

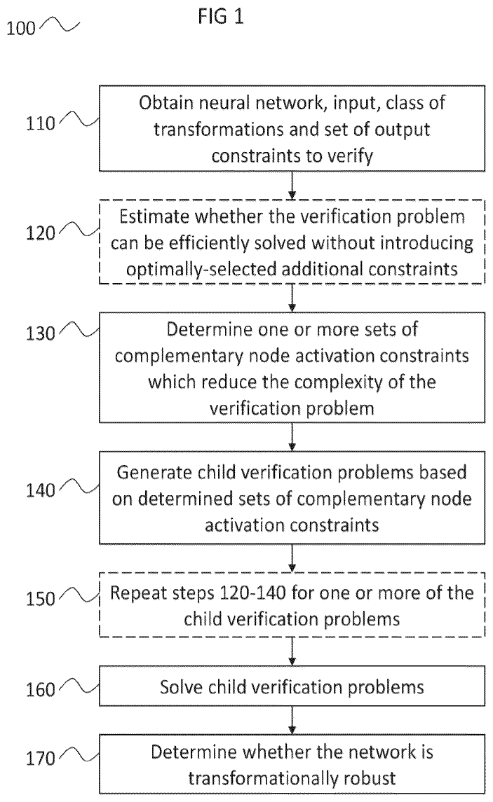

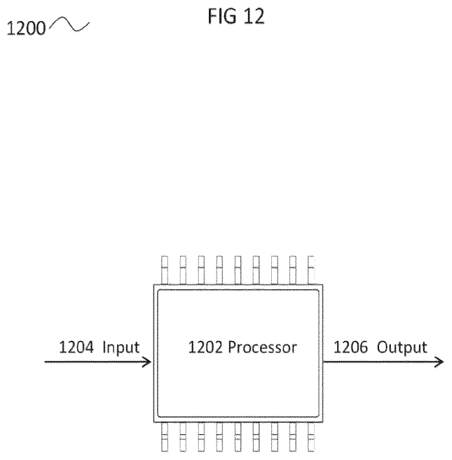

FIG. 1 shows an example method 100 for verifying the transformational robustness of a neural network, which comprises steps 110-160. Method 100 can be performed by a data processing apparatus, such as the apparatus described further below with reference to FIG. 12.

At step 110, a neural network, an input for the neural network, a class of transformations to be applied to the input, and a set of output constraints to be verified, may be obtained. These objects—the neural network, the input, the class of transformations, and the set of output constraints—can define the transformational robustness verification problem to be solved.

The neural network may be specified, for example, in terms of its architecture (i.e. the form of the function performed by each node, and the order in which these functions are applied to calculate the network's output from the network's input) and its weights (i.e. the parameter values used to parametrise the function performed by each node). The neural network may have been trained to perform a specific task, such as image classification, object detection or control of a robot, vehicle, aircraft or industrial plant. While the present technique is illustrated with reference to a multilayer perceptron network (also known as a ‘vanilla’ neural network), it is readily applicable to all types of artificial neural networks including convolutional neural networks and recurrent neural networks, all of which are mathematically equivalent to a multilayer perceptron network.

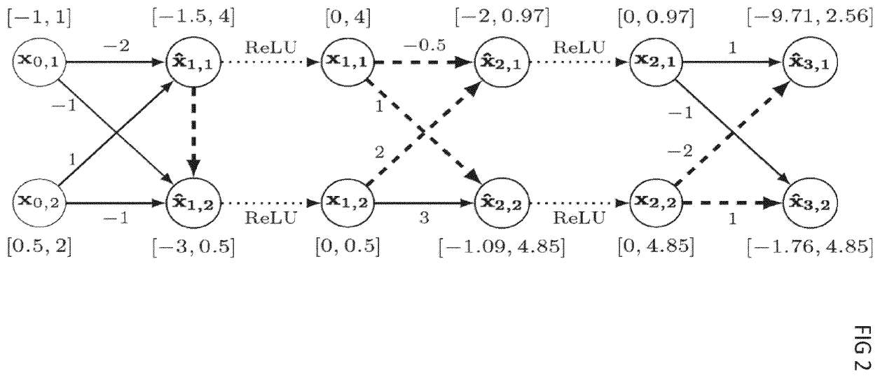

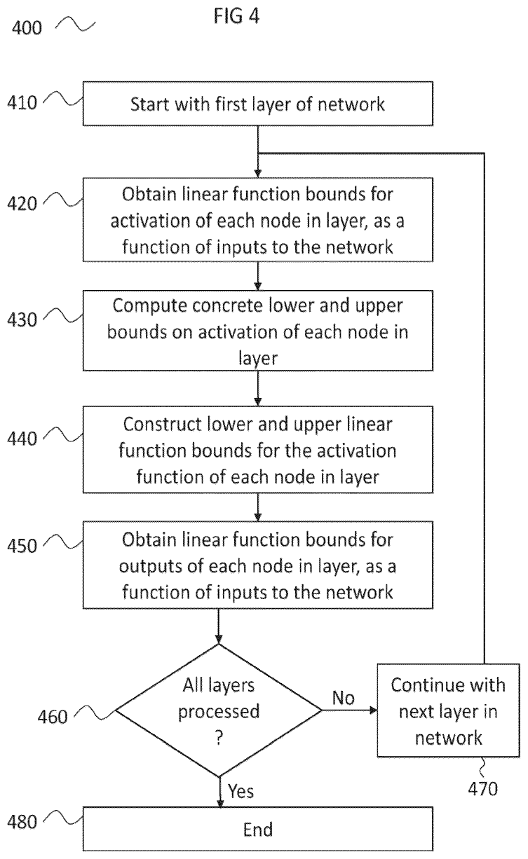

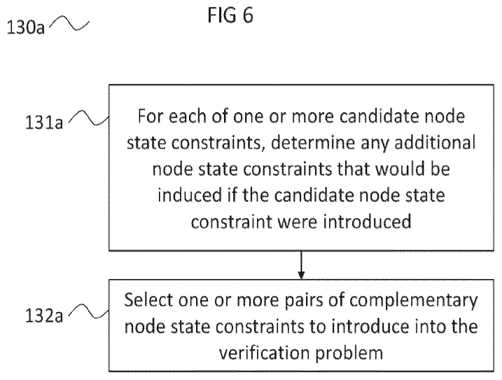

FIG. 2 depicts such an example neural network, which has two inputs x_{0,1} and x_{0,2}, and three layers, each comprising two nodes. To help distinguish each node's pre-activation from the node's output, each node n_{i,v} is represented in two stages: first the weighted linear combination for obtaining the node pre-activation \hat{x}_{i,v} from the node's inputs is shown, then the activation function which is applied to the node pre-activation î_{i,v} to obtain the node output x_{i,v} is shown. The nodes in the final (third) layer do not apply an activation function to their pre-activations, so that the output of the network is the concatenation of the pre-activations of the third layer. In the example of FIG. 2, the activation functions are all ReLUs. The arrows represent the weighted linear combinations, with weights indicated as numbers next to the arrows. The intervals above the input x_{0,1} and below the input x_{0,2} define intervals within which the inputs are allowed to vary, according to the class of transformations obtained at step 110 of FIG. 1; here, the class of transformation constrains x_{0,1}∈[−1; 1] and x_{0,2}∈[0.5; 2]. The intervals above and below the pre-activations and outputs of nodes represent concrete lower and upper bounds on the values of these pre-activations and outputs, which may be calculated at step 130 of FIG. 1, for example using the SIP process of FIG. 4. Finally, the dashed arrows between nodes represent dependencies between candidate node state constraints which may be identified at step 132a of FIG. 6.

Returning to step 110 of FIG. 1, the input for the neural network may be an input at which it is desirable to verify transformational robustness. For example, the input may be an input that is unambiguously known to correspond to a particular class, label or output range. In such a case, the neural network can be expected to continue predicting the same class, label or output range when small perturbations are applied to the input. For example, if the neural network is trained to perform image classification, a clear and unobstructed photograph of a cat could be expected to continue to be recognised by the neural network as a photo of a cat when small perturbations are applied.

The class of transformations may define the perturbations of the input for which the neural network output is to satisfy the output constraints. In some embodiments, the class of transformations may be defined in terms of a range for each component of the neural network's input, within which the component is to vary. In other embodiments, the class of transformations may be defined by a bound on a global metric, such as by defining a maximum value for the l_{∞}-distance between the original input and the perturbed input. In yet other embodiments, the class of transformations may be specifically adapted to the task for which the network is trained: for example, for a network trained for image recognition, a class of affine or photometric transformations can be defined, for example in the manner described in WO 2020/109774 A1. In general, the class of transformations may be specified in terms of a set of algebraic constraints that are satisfied when applying any transformation in the class to the input obtained at step 110.

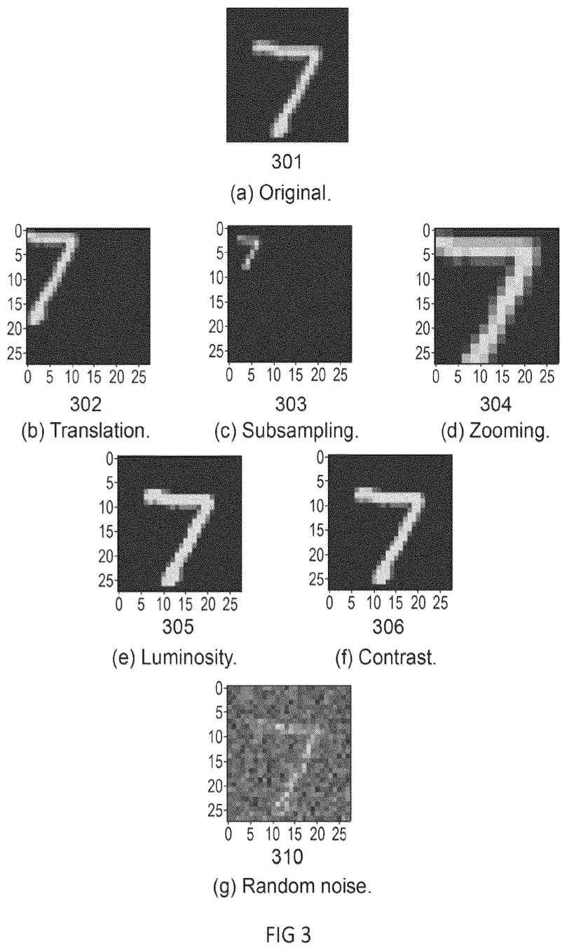

Typically, the input and class of transformations may be chosen such that the input sufficiently unambiguously belongs to a particular class and the class of transformations define small enough perturbations that the neural network may be expected not to substantially change its output when the transformations are applied to the input. A visually illustrative example of this is provided in FIG. 3, which depicts example affine (302-304), photometric (305-306) and random noise (310) transformations applied to an original image (301). As can be seen, the transformations may be chosen such that the semantic content of the image is unchanged.

The set of output constraints define a maximum range within which the outputs of the neural network should vary if the transformational robustness property is to be satisfied. In general, any set of algebraic constraints that defines a region within which the neural network's output should remain can be used as the set of output constraints.

For example, the set of output constraints may be defined in terms of linear inequalities of the form a^{T}\hat{x}ᵢ+b≤0, where \hat{x}ₗ is the output of the network, a is a vector of coefficients, and b is a constant. In some embodiments, the set of output constraints can be defined using the neural network itself; for example, if the network provides for a classification stage, the set of output constraints may correspond to ensuring that the output remains in the same predicted class.

At step 120, an estimation may be performed as to whether the transformational robustness verification problem defined by the objects received at step 110 can be efficiently solved without introducing judiciously-chosen additional constraints. This is useful because if the verification problem appears to be efficiently solvable without introducing the most optimal constraints, it may be more computationally efficient to directly solve the verification problem without first performing computations (e.g. at step 130) to judiciously determine sets of complementary node pre-activation constraints which reduce the complexity of the verification problem. To perform this estimation, the verification problem may be expressed as a set of algebraic constraints (e.g. as described in WO 2020/109774 A1), and a solving algorithm may be started to attempt to find a solution to the verification problem. While the algorithm is running, one or more indicators of the algorithm's progress may be measured, in order to estimate whether meaningful progress is being made towards finding a solution to the set of constraints. If progress is too slow or inefficient (e.g. if the one or more indicators fail to satisfy a threshold), the solving algorithm may be stopped and the method may advance to step 130. On the contrary, if the algorithm appears to be progressing effectively in the search for a solution, it may be allowed to run until it terminates, or until progress slows down.

For example, a branch-and-bound algorithm solves a set of algebraic constraints, where some of the constraints are binary (e.g. a Mixed-Integer Linear Program (MILP)), in an iterative manner, by solving tighter and tighter relaxations (e.g. a Linear Program (LP) relaxation) of the set of algebraic constraints, which bound more and more of the binary variables to the values 0 and 1. When using a branch-and-bound algorithm to solve the set of algebraic constraints, the “node throughput”, that is, the speed at which the relaxation (e.g. the LP) at each iteration is solved, is a good indicator of how efficiently progress is being made towards solving the problem. Other suitable indicators may also be used, such as those outlined in E. Klotz and A. Newman, Practical guidelines for solving difficult mixed integer linear programs, Surveys in Operations Research and Management Science, 18(1-2):18-32, 2013.

At step 130, one or more sets of complementary node pre-activation constraints are determined which reduce the complexity of the verification problem. In particular, several candidate node pre-activation constraints may be evaluated, measuring for each the extent to which the candidate node pre-activation constraint would reduce the complexity of solving the verification problem if it were introduced into the verification problem. One or more sets of complementary node pre-activation constraints for generating child verification problems may then be selected based on the evaluation.

For example, pairs of complementary node pre-activation constraints may be evaluated, and the pairs which are most promising for reducing the complexity of solving the verification problem may be chosen. The constraints in each set may be complementary in that at least one of them is always true over the entire range of neural network inputs induced by the neural network input and class of transformations obtained at step 110. For example, for each node pre-activation constraint of the form \hat{x}_{i,v}≤t_{i,v} which is evaluated, the complementary node pre-activation constraint \hat{x}_{i,v}≥t_{i,v} may also be evaluated.

In contrast to prior approaches which focused on partitioning the input space of the neural network into several cases, being able to introduce constraints on the pre-activation of potentially any node in the network provides several advantages. First of all, starting with a far larger search space of constraints can improve the quality of the constraint that is actually selected. Moreover, introducing constraints on the pre-activations of nodes in the network is particularly advantageous, because most of the nodes operate in a small region of their normal operating range as a result of the typically limited range of transformations, and so only a relatively small proportion of nodes will have wild swings in their pre-activations: constraining those can lead to large reductions in the complexity of the verification problem. Furthermore, constraining the pre-activations of nodes often enables further constraints to be obtained for the pre-activations of other nodes in a cascade effect, which enables one node pre-activation constraint to have a leveraged impact on reducing the complexity of the verification problem.

Advantageously, the measure of the extent to which a node pre-activation constraint would reduce the complexity of the verification problem may be defined as a measure of the effect of introducing the node pre-activation constraint on the numerical ranges of the pre-activations of other nodes in the network. Intuitively, introducing a node pre-activation constraint on a node can both reduce the actual range of the pre-activations of other nodes (for example, nodes in subsequent layers, which depend on the node's output) and reduce the distance between the estimated bounds and the actual ranges of pre-activations. By these two consequences, introducing a node pre-activation constraint can cause bounds on the ranges of pre-activations of other nodes to shrink. This can render the verification problem more tightly constrained. In particular, for some nodes the estimated bounds on pre-activations may have shrunk enough to have certainty that the node is always active or inactive. Moreover, the shrinkage in the bounds of the pre-activations of nodes can propagate all the way to the output nodes, which can lead to the output constraints specified at step 110 being satisfied. All these effects have a positive impact on reducing the complexity of verification. Thus, by measuring the extent to which the estimated bounds on the ranges of node pre-activations can be made to shrink, suitable node pre-activation constraints can be chosen for reducing the complexity of the verification problem.

For example, if the verification problem is to be solved by generating tighter and tighter linear problem (LP) relaxations of the verification problem (as in the branch-and-bound algorithm for solving Mixed-Integer Linear Programs), the complexity of solving the verification problem may on average be reduced optimally by reducing the number of un-bound integer variables as much as possible. Thus, node pre-activation constraints can be chosen such as to maximise the number of nodes whose pre-activations are wholly positive or wholly negative, as will be described in more detail with reference to FIG. 6.

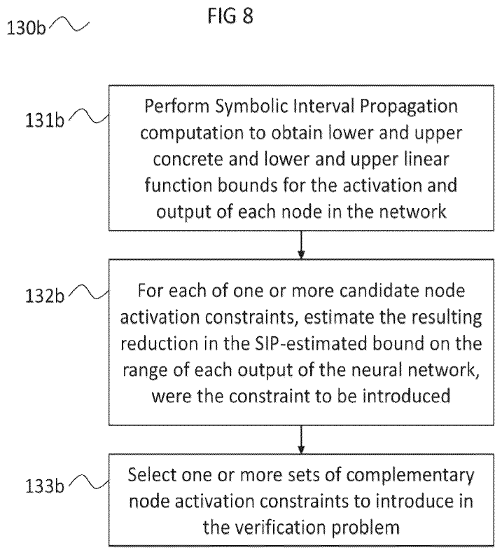

As another example, if the verification problem is to be solved by recursively splitting the pre-activation space of nodes into different cases, where each case introduces additional node pre-activation constraints and calculates new bounds on the neural network outputs, the complexity of solving the verification problem will on average be reduced optimally by attempting to reduce the uncertainty in the output bounds as much as possible. Thus, node pre-activation constraints which lead to a maximal reduction in this uncertainty can be chosen, as will be described in more detail with reference to FIG. 8.

Advantageously, the reductions in the numerical ranges of node pre-activations caused by introducing a node pre-activation constraint may be determined based on lower and upper symbolic bounds which may be obtained for the pre-activations and outputs of the nodes in the neural network. The lower and upper symbolic bounds on a node n_{i,v}'s pre-activation \hat{x}_{i,v} are two symbolic expressions [symbol] low_{i,v}(x₀) and [symbol] up_{i,v}(x₀), in terms of the neural network's input x₀, such that [symbol] low_{i,v}(x₀)≤\ddot{x}_{i,v}≤ [symbol] up_{i,v}(x₀) when the input to the neural network is set to any value x₀ which can be reached by the class of transformations obtained at step 110. Similarly, the lower and upper symbolic bounds on a node n_{i,v}'s output x_{i,v} are two symbolic expressions eqlow_{i,v}(x₀) and equp_{i,v}(x₀), in terms of the neural network's input x₀, such that eqlow_{i,v}(x₀)≤x_{i,v}≤equp_{i,v}(x₀) when the input to the neural network is set to any value x₀ which can be reached by the class of transformations. In particular, [symbol] low_{i,v}, [symbol] up_{i,v}, eqlow_{i,v} and equp_{i,v} may be linear functions.

These lower and upper symbolic bounds on the pre-activations and outputs of nodes may be obtained by way of a Symbolic Interval Propagation (SIP) computation. Broadly speaking, the SIP technique consists in progressively calculating lower and upper linear function bounds for the pre-activations and outputs of the nodes in the network, starting from the first layer, and progressing layer by layer. This is achieved in each layer by combining linear function bounds obtained for the outputs of the previous layer using the weighted combination defined for the layer in order to obtain linear function bounds for the pre-activations of the nodes in the layer in terms of the input to the network; performing a linear optimisation over the possible values of the input to the network to find lower and upper concrete bounds on the pre-activations of the nodes, based on the linear function bounds; based on the obtained lower and upper concrete bounds on the pre-activations of the nodes, constructing lower and upper linear function bounds on the activation functions of the nodes; and obtaining lower and upper linear function bounds on the outputs of the nodes in terms of the input to the neural network. This final step of obtaining lower and upper linear function bounds on the outputs of the nodes in terms of the input to the neural network may be achieved by substituting the linear function bounds for the pre-activations of the nodes into the linear function bounds on the activation functions of the nodes, or, for enhanced precision, by first substituting into the linear function bounds on the activation functions of the nodes, linear function bounds of the node's pre-activation in terms of the previous layer's pre-activations, and then substituting, into the resulting expressions, linear function bounds of the previous layer's nodes' pre-activations in terms of the pre-activations of the layer before that, and so forth until an expression in terms of the inputs to the neural network is obtained. An example SIP process is illustrated with reference to FIG. 4.

The SIP technique is particularly beneficial in the context of the present disclosure in that it expresses the numerical ranges of pre-activations and outputs of each node as a symbolic interval, i.e. a lower and an upper bound which are in the form of symbolic expressions, in terms of the outputs of the nodes in the previous layer. As a result of this, it becomes possible to express the numerical ranges of pre-activations and outputs of nodes in terms of the numerical ranges of pre-activations and outputs of other nodes, thereby enabling the effect of introducing a node pre-activation constraint to be quantified in other nodes. Advantageously, the SIP technique yields linear bounds which are computationally simple to manipulate and combine together in order to quantify the effect of introducing a node pre-activation constraint on reducing the numerical range of other nodes. However, in general, any technique which enables the numerical ranges of pre-activations and outputs of nodes to be expressed in terms of the numerical ranges of pre-activations and outputs of other nodes could be used, although the SIP technique may be more accurate and/or computationally efficient.

At step 140, one or more child verification problems may be generated by introducing the determined sets of complementary node pre-activation constraints. Namely, the child verification problems may be constructed by generating all possible combinations of the sets of constraints such that exactly one constraint is selected from each set of complementary node pre-activation constraints. For example, if each set of complementary node pre-activation constraints comprises two node pre-activation constraints, and there are k sets of complementary node pre-activation constraints, 2^{k} different child verification problems will be generated. Each child verification problem may be constructed by starting from the original verification problem and further constraining it with the combination of node pre-activation constraints chosen for it. In addition, any further node pre-activation constraints induced by the chosen node pre-activation constraints (such as those determined at step 131a of FIG. 6) may be introduced into the child verification problem. The child verification problems may be complementary, in that if all pass verification, the original verification problem is proved to be transformationally robust, whereas if a counter-example is found for one of them, the counter-example is valid for the original verification problem. Moreover, because the introduced node pre-activation constraints are chosen to reduce the complexity of the verification problem, solving all the child verification problems may be less computationally costly than directly solving the original verification problem.

At step 150, which is optional, steps 120-140 may be repeated on one or more of the child verification problems in the place of the original verification problem. For example, further child verification problems may be constructed by decomposing some of the child verification problems obtained from the original verification problem, e.g., those which fail to pass the test at step 120 as to whether they can be efficiently solved without further decomposition. The further child verification problems may themselves be the object of further decomposition: thus steps 120-140 may be repeated in a recursive fashion, in order to obtain further reductions in the complexity of the child verification problems, if such reductions can be obtained.

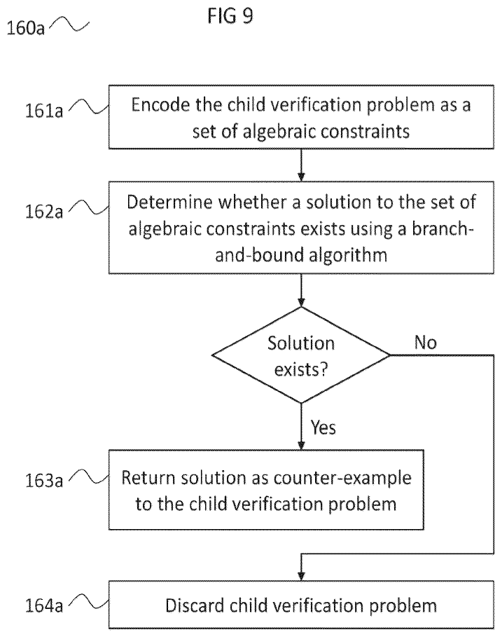

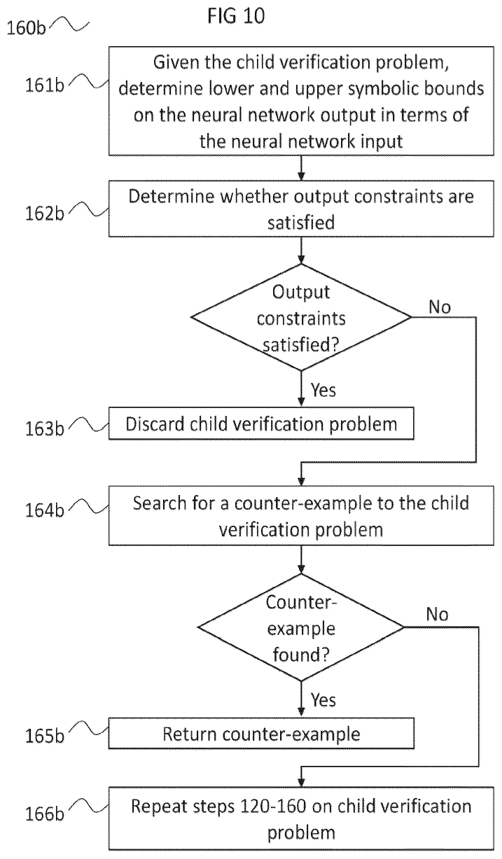

At step 160, the child verification problems obtained at step 140, or the final set of child verification problems if further decomposition(s) are performed at step 150, are solved in order to obtain an answer to the original verification problem. In particular, for each child verification problem, the existence of a counter-example to the child verification problem—i.e. a particular transformation in the class of transformations such that when the input to the neural network is transformed according to the particular transformation, the additional constraints in the child verification problem are satisfied but one or more of the output constraints obtained at step 110 are not satisfied—may be determined. For this, the specific algorithms described with reference to FIGS. 9 and 10 may be of particular benefit in the context of the present disclosure. In particular, where the child verification problems have been generated with the aim to reduce the number of binary variables in the formulation of the child verification problems as sets of algebraic constraints (such as when using the guiding method of FIG. 6), using the algorithm of FIG. 9 to solve each child verification problem, which involves encoding a child verification problem as a set of algebraic constraints and determining whether the set admits a solution, may be particularly beneficial. Alternatively, where the child verification problems have been generated with the aim of optimally reducing the uncertainty in bounds on the output of the neural network (such as when using the guiding method of FIG. 8), using the algorithm of FIG. 10 to solve each child verification problem, which involves iteratively reducing this uncertainty until the existence of a counter-example is excluded or a counter-example is found, may be particularly beneficial.

At step 170, based on the outcome of solving the child verification problems, the transformational robustness property defined by the neural network, input, class of transformations and set of output constraints at step 110 is determined to be satisfied or not satisfied. In particular, if the solving led to a counter-example being found for one of the child verification problems, so that a particular transformation in the class of transformations is obtained such that the output of the neural network breaches one of the output constraints when the input to the neural network is transformed according to the particular transformation, then the transformational robustness property is disproven. Otherwise, if all child verification problems were solved such that the existence of a counter-example is disproven, then the transformational robustness property is proven. In addition, if a counter-example is generated, the counter-example may be used to generate one or more inputs for training the network to improve its robustness.

FIG. 4 shows an example SIP process, comprising steps 410-480. Steps 420-450 may be performed for each layer in the network, starting from the first layer (step 410). While some layers in the network have not yet been processed (step 460), steps 420-450 may be repeated for each subsequent layer (step 470), until all layers have been processed (step 480).

At step 420, for each node n_{j,u} in a given layer j, a lower and an upper linear function bound [symbol] low_{j,u}(x₀) and [symbol] up_{j,u}(x₀) may be obtained for the node's pre-activation \hat{x}_{j,u}, in terms of the input x₀ to the neural network. These may be obtained based on lower and upper linear function bounds eqlow_{j-1,v}(x₀) and equp_{j-1,v}(x₀) on the outputs of the nodes in the previous layer, in terms of the input x₀ to the neural network, which may have been obtained when performing step 450 on the previous layer; or, if the layer is the first layer of the network, the input x₀ to the neural network may be regarded as the output of the “previous layer”, for which lower and upper linear functions bounds (in this case the identity function) are trivially obtained.

Specifically, given that the bounds eqlow_{j-1,v}(x₀) and equp_{j-1,v}(x₀) satisfy eqlow_{j-1,v}(x₀)≤x_{j-1,v}≤equp_{j-1,v}(x₀) for any input x₀ induced by the class of transformations obtained at step 110, and given that the weighted combination performed by the node n_{j,u} can be expressed by the equation

\hat{x}_{j,u}=ΣᵥW_{u,v}^{(j)}x_{j-1,v}+bᵤ^{j}

where \hat{x}_{j,u} is the pre-activation of node n_{j,u}, W_{u,v}^{(j)} is the weight from node n_{j-1,v} to n_{j,u}, and bᵤ^{j} is an optional bias term for node n_{j,u}, lower and upper linear function bounds on the pre-activation \hat{x}_{j,u} may be constructed as

[symbol]

low_{j,u}(x₀)=Σ_{v|W}_{_{u,v}}_{^{(j)}}_{≥0}eqlow_{j-1,v}(x₀)+Σ_{v|W}_{_{u,v}}_{^{(j)}}_{≤0}W_{u,v}^{(j)}equp_{j-1,v}(x₀)+bᵤ^{j}

[symbol]

up_{j,u}(x₀)=Σ_{v|W}_{_{u,v}}_{^{(j)}}_{≤0}eqlow_{j-1,v}(x₀)+Σ_{v|W}_{_{u,v}}_{^{(j)}}_{≥0}W_{u,v}^{(j)}equp_{j-1,v}(x₀)+bᵤ^{j}

which satisfy [symbol] low_{j,u}(x₀)≤\hat{x}_{j,u}≤ [symbol] up_{j,u}(x₀) for any input x₀ induced by the class of transformations obtained at step 110.

Optionally, in order to improve the precision of the final linear function bounds obtained by the algorithm, lower and upper linear function bounds [symbol] low′_{j,u}(\hat{x}ⱼ₋₁) and [symbol] up′_{j,u}(\hat{x}ⱼ₋₁) may be obtained for the pre-activation of each node n_{j,u} in layer j in terms of the pre-activations of the previous layer, for every layer after the first. These may be computed based on lower and upper linear function bounds actlow_{j-1,v}(\hat{x}_{j-1,v}) and actup_{j-1,v}(\hat{x}_{j-1,v}) on the outputs of the nodes in the previous layer, in terms of the pre-activations \hat{x}ⱼ₋₁ of the previous layer, which may have been obtained when performing step 440 on the previous layer. The rest of the process for obtaining such linear function bounds [symbol] low′_{j,u}(\hat{x}ⱼ₋₁) and [symbol] up′_{j,u}(\hat{x}ⱼ₋₁) is otherwise identical to that for obtaining the linear function bounds [symbol] low_{j,u}(x₀) and [symbol] up_{j,u}(x₀). A SIP process that implements both this optional computation and the optional computation at step 450 may be referred to as a Reverse Symbolic Interval Propagation (RSIP).

At step 430, for each node n_{j,u} in layer j, concrete lower and upper bounds \hat{l}_{j,u} and û_{j,u} on the pre-activation \hat{x}_{j,u} of node n_{j,u} may be obtained. This may be achieved by performing a linear optimisation on the linear function bounds [symbol] low_{j,u}(x₀) and [symbol] up_{j,u}(x₀) over a range of network inputs x₀ induced by the class of transformations. For example, the lower and upper concrete bounds may be obtained as

$${\hat{l}}_{j , u} = {min}_{{x}_{0}} {low}_{u , j} ( {x}_{0} ) and {\hat{u}}_{j , u} = {max}_{{x}_{0}} {up}_{j , u} ( {x}_{0} ) .$$

At step 440, lower and upper linear function bounds actlow_{j,u}(\hat{x}_{j,u}) and actup_{j,u}(\hat{x}_{j,u}) may be constructed for the pre-activation function of each node n_{j,u} in layer j. Indeed, as a result of having obtained the concrete lower and upper bounds \hat{l}_{j,u} and û_{j,u}, the domain [\hat{l}_{j,u},û_{j,u}] over which the pre-activation function of node n_{j,u} operates is known. Therefore, linear function bounds actlow_{j,u}(\hat{x}_{j,u}) and actup_{j,u}(\hat{x}_{j,u}) may be constructed such that actlow_{j,u}(\hat{x}_{j,u})≤activation(\hat{x}_{j,u})≤actup_{j,u}(\hat{x}_{j,u}) is valid over the entire domain \hat{x}_{j,u}∈[\hat{l}_{j,u},û_{j,u}], and hence the bounds are valid over the entire range of network inputs induced by the class of transformations.

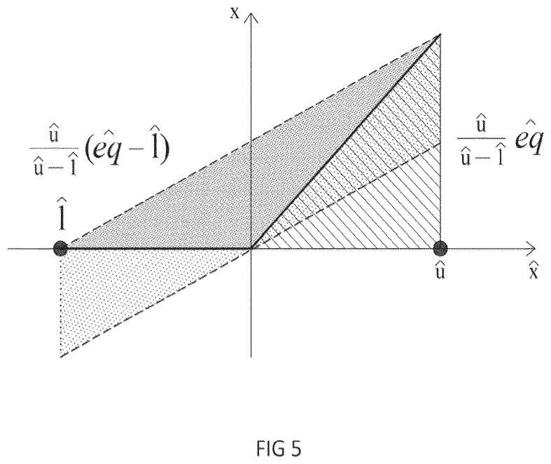

For example, where the pre-activation function is a Rectified Linear Unit (ReLU), the linear function bounds actlow_{j,u}(\hat{x}_{j,u}) and actup_{j,u}(\hat{x}_{j,u}) may be defined as follows. If both \hat{l}_{j,u} and û_{j,u} are positive, then the ReLU always operates in the positive domain, and therefore the bounds can be defined as actlow_{j,u}(\hat{x}_{j,u})=actup_{j,u}(\hat{x}_{j,u})=\hat{x}_{j,u}. Conversely, if both \hat{l}_{j,u} and û_{j,u} are negative, then the ReLU always operates in the negative domain, and therefore the bounds can be defined as actlow_{j,u}(\hat{x}_{j,u})=actup_{j,u}(\hat{x}_{j,u})=0. Finally, if \hat{l}_{j,u} is negative and û_{j,u} is positive, the linear function bounds can be defined as actlow_{j,u}(\hat{x}_{j,u})=(û_{j,u})/(û_{j,u}−\hat{l}_{j,u})·\hat{x}_{j,u} and actup_{j,u}(\hat{x}_{j,u})=(û_{j,u})/(û_{j,u}−\hat{l}_{j,u})·(\hat{x}_{j,u}−\hat{l}_{j,u}), as illustrated by the two dashed lines in FIG. 5. In this case, the uncertainty introduced by approximating the ReLU with the linear function bounds is given by the distance between the two lines, namely, −l_{j,u}·û_{j,u}/(û_{j,u}−\hat{l}_{j,u}).

Finally, at step 450, for each node n_{j,u} in layer j, lower and upper linear function bounds eqlow_{j,u}(x₀) and equp_{j,u}(x₀) on the node's output x_{j,u} may be obtained, in terms of the input x₀ to the neural network. This may be achieved simply by substituting the linear function bounds [symbol] low_{j,u}(x₀) and [symbol] up_{j,u}(x₀) for the node's pre-activation \hat{x}_{j,u} into the linear function bounds actlow_{j,u}(\hat{x}_{j,u}) and actup_{j,u}(\hat{x}_{j,u}) obtained for the node's pre-activation function. For example, one may construct eqlow_{j,u}(x₀)=actlow_{j,u}( [symbol] low_{j,u}(x₀)) and equp_{j,u}(x₀)=actup_{j,u}( [symbol] up_{j,u}(x₀)).

Optionally, for improved precision, the linear function bounds eqlow_{j,u}(x₀) and equp_{j,u}(x₀) may be obtained by substituting, into the linear function bounds actlow_{j,u}(\hat{x}_{j,u}) and actup_{j,u}(\hat{x}_{j,u}) obtained for the node's pre-activation function, linear function bounds [symbol] low′_{j,u}(\hat{x}ⱼ₋₁) and [symbol] up′_{j,u}(\hat{x}ⱼ₋₁) on the node's activation in terms of the previous layer's pre-activations, in order to obtain linear function bounds for the node's output x_{j,u} in terms of the pre-activations \hat{x}ⱼ₋₁ of the previous layer. The linear function bounds [symbol] low′_{j,u}(\hat{x}ⱼ₋₁) and [symbol] up′_{j,u}(\hat{x}ⱼ₋₁) may for example have been constructed at step 420, as described above. Then, by substituting, into the resulting linear function bounds, linear function bounds [symbol] low′_{j-1,v}(\hat{x}ⱼ₋₂) and [symbol] up′_{j-1,v}(\hat{x}ⱼ₋₂) of the previous layer's nodes' pre-activations \hat{x}ⱼ₋₁ in terms of the pre-activations \hat{x}ⱼ₋₂ of the layer before that, and so forth, lower and upper linear function bounds eqlow_{j,u}(x₀) and equp_{j,u}(x₀) may be obtained in terms of the inputs to the neural network. This process yields bounds with improved precision, because in this way the coefficients of the plurality of linear function bounds [symbol] low′_{j-1,v}(\hat{x}ⱼ₋₂) and [symbol] up′_{j-1,v}(\ddot{x}ⱼ₋₂), one for each node n_{j-1,v} in layer j−1, can cancel each other out before substituting in the linear function bounds for the pre-activations \hat{x}ⱼ₋₂ of the nodes in layer j−2 in terms of the pre-activations \hat{x}ⱼ₋₃ of the nodes in layer j−3, and so forth. Given that the uncertainties introduced by the SIP approximation at each layer compound exponentially, any reduction in the uncertainty at a layer can significantly narrow the bounds predicted for the neural network outputs. A SIP process that implements both this optional computation and the optional computation at step 420 may be referred to as a Reverse Symbolic Interval Propagation (RSIP).

While the process described above with reference to FIG. 4 can be implemented by explicitly generating the lower and upper linear function bounds outlined above at steps 420-450, those lower and upper linear function bounds can also be implicitly represented in terms of a linear function qᵤ^{j}(x₀) and one SIP approximation error ϵᵤ^{j} for each node n_{j,u} in the network, where the linear function qᵤ^{j}(x₀) defines the direction of the lower and upper linear function bounds [symbol] low_{j,u}(x₀) and [symbol] up_{j,u}(x₀) of the pre-activation of node n_{j,u}, and the error term ϵᵤ^{j} is the distance between the lower and upper linear function bounds, ϵᵤ^{j}=equp_{j,u}(x₀)−eqlow_{j,u}(x₀). Such a variant of the SIP process can be referred to as an Error-based Symbolic Interval Propagation (ESIP), and may be beneficial when used for networks with any activation function, including ReLU. The SIP approximation error ϵᵤ^{j} quantifies the uncertainty introduced at the output of node n_{j,u} by approximating the activation function of node n_{j,u} into lower and upper linear function bounds. This is an “uncertainty” in the sense that the approximation leads to a loss of information in that when the neural network input is set to a particular value x₀, the node's output x_{j,u} is no longer precisely known, but rather only an interval [eqlow_{j,u}(x₀); equp_{j,u}(x₀)] within which x_{j,u} must lie. For example, as noted above for step 440 of FIG. 4, when the activation function is a ReLU, the SIP approximation error may be obtained as

$${ϵ}_{u}^{j} = \{ \begin{matrix}- {\hat{l}}_{j , u} \cdot {\hat{u}}_{j , u} / ( {\hat{u}}_{j , u} - {\hat{l}}_{j , u} ) & if {\hat{I}}_{j , u} \leq 0 and {\hat{u}}_{j , u} \geq 0 \\ 0 & otherwise\end{matrix}$$

The linear function qᵤ^{j}(x₀) may be a linear function, whose direction gives the direction of the lower and upper linear function bounds [symbol] low_{j,u}(x₀) and [symbol] up_{j,u}(x₀). The linear function qᵤ^{j}(x₀) may have a constant term that keeps track of the network's bias terms, if present.

The lower and upper linear function bounds [symbol] low_{j,u}(x₀) and [symbol] up_{j,u}(x₀) on the pre-activations of a node n_{j,u} may then be reconstructed as

[symbol]

low_{j,u}(x₀):=qᵤ^{j}(x₀)+Σᵢ₌₀^{j-1}Σ_{v|ϵ}_{_{v,u}}_{^{i,j}}_{≤0}ϵ_{v,u}^{i,j}

[symbol]

up_{j,u}(x₀):=qᵤ^{j}(x₀)+Σᵢ₌₀^{j-1}Σ_{v|ϵ}_{_{v,u}}_{^{i,j}}_{≥0}ϵ_{v,u}^{i,j}

where each term ϵ_{v,u}^{i,j} is obtained by propagating the SIP approximation error ϵᵥⁱ obtained for a node n_{i,v} through the network all the way to node n_{j,u} that is, by applying the weighted linear combinations defined by the network from node n_{i,v} to node n_{j,u}. This term ϵ_{v,u}^{i,j} represents the contribution of the uncertainty introduced by approximating the activation function of node n_{i,v} into a lower and upper linear function bound to the total uncertainty for the pre-activation of the subsequent node n_{j,u}. Formally speaking, each term ϵ_{v,u}^{i,j} may be obtained through the inductive relationship

$$\{ \begin{matrix}{ϵ}_{v , s}^{i , i + 1} & = {W}_{v , s}^{i + 1} {ϵ}_{v}^{i} \\ {ϵ}_{v , t}^{i , h + 1} & = {\sum }_{s} {W}_{s , t}^{h + 1} {a}_{s}^{h} {ϵ}_{v , s}^{i , h} for any h \geq i + 1\end{matrix}$$

or a mathematical equivalent, where W_{s,t}^{h+1} is the weight from node n_{h,s} to node n_{h+1,t} and aₛ^{h} is the slope of the lower linear function bound actlow_{h,s}(\hat{x}_{h,s}) of the activation of node n_{h,s}—that is, actlow_{h,s}(\hat{x}_{h,s}) can be expressed as actlow_{h,s}(\hat{x}_{h,s})=aₛ^{h}\hat{x}_{h,s}+cₛ^{h}.

It will be noted that such an ESIP process can be implemented without explicitly constructing linear function bounds on the pre-activations and outputs at each node, but rather, the linear functions qᵤ^{j}(x₀) and the SIP approximation errors ϵᵤ^{j} for each layer may iteratively be constructed from those obtained for the previous layer. For example, instead of constructing the linear function bounds [symbol] low_{j,u}(x₀) and [symbol] up_{j,u}(x₀) for a node n_{j,u} at step 420, the linear function qᵤ^{j}(x₀) may be obtained directly from the linear functions qᵥ^{j-1}(x₀) for each node n_{j-1,v}, for example through the equation qᵤ^{j}(x₀)=ΣᵥW_{v,u}^{j}(aᵥ^{j-1}qᵥ^{j-1}(x₀)+cᵥ^{j-1})+bᵤ^{j} where W_{v,u}^{j} is the weight from node n_{j-1,v} to node n_{j,u}, aᵥ^{j-1} and cᵥ^{j-1} are respectively the slope and the constant term of the lower linear function bound actlow_{j-1,v}(\hat{x}_{j-1,v}) of the activation of node n_{j-1,v}, such that actlow_{j-1,v}(\hat{x}_{j-1,v})=aᵥ^{j-1}\hat{x}_{j-1,v}+cᵥ^{j-1}, and bᵤ^{j} is the bias term for node n_{j,u}. Similarly, the SIP approximation error ϵᵤ^{j} may be obtained directly from the relaxation of the activation function, in terms of the lower and upper concrete bounds \hat{l}_{j,u} and û_{j,u} on the pre-activation \hat{x}_{j,u} of node n_{j,u},

$${\hat{l}}_{j , u} = {min}_{{x}_{0}} {low}_{u , j} ( {x}_{0} ) = {min}_{{x}_{0}} ( {q}_{u}^{j} ( {x}_{0} ) ) + {\sum }_{i = 0}^{j - 1} {\sum }_{v \vert {ϵ}_{v , u}^{i , j} \leq 0} {ϵ}_{v , u}^{i , j}$$

$${\hat{u}}_{j , u} = {max}_{{x}_{0}} {up}_{u , j} ( {x}_{0} ) = {max}_{{x}_{0}} {q}_{u}^{j} ( {x}_{0} ) + {\sum }_{i = 0}^{j - 1} {\sum }_{v \vert {ϵ}_{v , u}^{i , j} \geq 0} {ϵ}_{v , u}^{i , j}$$

For example, when the activation function is a ReLU, the SIP approximation error may be obtained as

$${ϵ}_{u}^{j} = \{ \begin{matrix}- {\hat{l}}_{j , u} \cdot {\hat{u}}_{j , u} / ( {\hat{u}}_{j , u} - {\hat{l}}_{j , u} ) & if {\hat{l}}_{j , u} \leq 0 and {\hat{u}}_{j , u} \geq 0 \\ 0 & otherwise\end{matrix}$$

For illustration, the SIP process is applied on the example network of FIG. 2 as follows. Starting at the first layer, at step 420 the lower and upper linear function bounds on the pre-activations \hat{x}_{1,1} and \hat{x}_{1,2} may be obtained as

[symbol]

low_{1,1}(x₀)= [symbol] up_{1,1}(\hat{x}₀)=−2x_{0,1}+x_{0,2}

[symbol]

low_{1,2}(x₀)= [symbol] up_{1,2}(\hat{x}₀)=−x_{0,1}−x_{0,2}

At step 430, given that x_{0,1}∈[−1; 1] and x_{0,2}∈[0.5; 2], the concrete lower and upper bounds on the pre-activations may therefore be obtained by linear optimisation as [\hat{l}_{1,1};û_{1,1}]=[−1.5; 4] and [\hat{l}_{1,2};û_{1,2}]=[−3;0.5].

At step 440, lower and upper linear function bounds on the activation functions of n_{1,1} and n_{1,2} may therefore be obtained as

$${actlow}_{1 , 1} ( {\hat{x}}_{1 , 1} ) = \frac{4}{4 + 1.5} \cdot {\hat{x}}_{1 , 1} = 0 \text{.73} \cdot {\hat{x}}_{1 , 1}$$

$${actup}_{1 , 1} ( {\hat{x}}_{1 , 1} ) = \frac{4}{4 + 1.5} \cdot ( {\hat{x}}_{1 , 1} + 1.5 ) = 0 \text{.73} \cdot {\hat{x}}_{1 , 1} + 1.09$$

$${actlow}_{1 , 2} ( {\hat{x}}_{1 , 2} ) = \frac{0.5}{0.5 + 3} \cdot {\hat{x}}_{1 , 2} = 0 \text{.14} \cdot {\hat{x}}_{1 , 2}$$

$${actup}_{1 , 2} ( {\hat{x}}_{1 , 2} ) = \frac{0.5}{0.5 + 3} \cdot ( {\hat{x}}_{1 , 2} + 3 ) = 0 \text{.14} \cdot {\hat{x}}_{1 , 2} + 0.43$$

At step 450, lower and upper linear function bounds on the outputs x_{1,1} and x_{1,2} may therefore be obtained as

eqlow_{1,1}(x₀)=1.46x_{0,1}+0.73x_{0,2}

equp_{1,1}(x₀)=1.46x_{0,1}+0.73x_{0,2}+1.09

eqlow_{1,2}(x₀)=0.14x_{0,1}−0.14x_{0,2}

equp_{1,2}(x₀)=0.14x_{0,1}−0.14x_{0,2}+0.43

Thus, by linear optimisation on these linear function bounds, concrete bounds may be obtained on the outputs x_{1,1} and x_{1,2} as 0≤x_{1,1}≤4 and 0≤x_{1,2}≤0.5.

Steps 420-450 may then be performed again on the subsequent nodes of the network, yielding the bounds indicated next to the pre-activations and outputs of nodes in FIG. 2.

Now turning to FIG. 6, a first example implementation of step 130 is described, which comprises steps 131a and 132a. This first example implementation involves evaluating node state constraints, i.e., node pre-activation constraints which constrain the pre-activation either to be positive or negative, and determining pairs of complementary node state constraints which reduce the complexity of the verification problem.

At step 131a, for each of one or more candidate node state constraints, any additional node state constraints that would be induced if the candidate node state constraint were introduced into the verification problem may be determined. Put another way, dependencies between candidate node state constraints may be determined—a first candidate node state constraint is said to depend on another candidate node state constraint if the other candidate node state constraint would induce the first candidate node state constraint if introduced into the verification problem.

To this end, a set of one or more candidate node state constraints which can be introduced into the verification problem may first be identified, in order to then attempt to induce additional node state constraints from them.

The set of candidate node state constraints may comprise node state constraints for nodes of the neural network which are identified as unstable or potentially unstable. This is because, when encoding a verification problem as a set of algebraic constraints, unstable nodes require an integer variable to represent; therefore, introducing a node state constraint, which turns an unstable node into a stable node, reduces the complexity of the verification problem. Moreover, in the algebraic constraint encoding, nodes identified as stable do not require any integer variables to represent, so identifying stable nodes greatly improves the speed of solving the verification problem.

To determine stable nodes, for one or more nodes of the neural network, bounds on the numerical range of the pre-activation of each node may be calculated, e.g. using the SIP process as described with reference to FIG. 1. The bounds defines a range within which the node's pre-activation remains when the input obtained at step 110 is subjected to the class of transformations. If the range is entirely negative or positive, the node is stable. Otherwise, that is, if the range covers both negative and positive values, the node is potentially unstable.

Having identified one or more unstable nodes (or one or more nodes determined to potentially be unstable), a set of one or more candidate node state constraints which can potentially be introduced into the verification problem may be constructed. In particular, for each unstable node of the one or more unstable nodes, the two complementary node state constraints can be constructed: one where the node is constrained to be active, and one where the node is constrained to be inactive.

For each candidate node state constraint in the set of candidate node state constraints, any additional node state constraints that can be induced from it may be determined. This may be performed in one or more of the several approaches outlined below.

In a first approach, given a candidate node state constraint selected from the set of candidate node state constraints, which constrains a node n_{i,q} to be active or to be inactive, the method may attempt to induce further node state constraints in the same layer i as the node n_{i,q}.

To this end, lower and upper linear function bounds eqlow_{i-1,v}(x₀) and equp_{i-1,v}(x₀) may be obtained for the outputs of the nodes n_{i-1,v} in the layer previous to node n_{i,q}, that is, layer i−1. These may be obtained using a SIP process as described with reference to FIG. 4; or, if the node n_{i,q} belongs to the first layer in the neural network, they may be defined as the identity function: eqlow_{0,v}(x₀)=equp_{0,v}(x₀)=x_{0,v}.

Having obtained the lower and upper linear function bounds eqlow_{i-1,v}(x₀) and equp_{i-1,v}(x₀) for the outputs of the nodes n_{i-1,v}, dependencies between the candidate node state constraint and node state constraints for other nodes in the layer of the node n_{i,q} may then be determined.

In particular, conditional lower and upper linear function bounds [symbol] low_{i,r|q=0}(x₀) and [symbol] up_{i,r|q=0} (x₀) for the pre-activation of a node n_{i,r} given that the pre-activation of node n_{i,q} is equal to zero, can be obtained for each node n_{i,r} in the same layer as node n_{i,q}.

These conditional lower and upper linear function bounds may be derived from the equations:

[symbol]

eqlow_{l,r|q=0}(x₀)=z⁻·equpᵢ₋₁(x₀)+z⁺·eqlowᵢ₋₁(x₀)

and

[symbol]

equp_{l,r|q=0}(x₀)=z⁺·equpᵢ₋₁(x₀)+z⁻·eqlowᵢ₋₁(x₀)

where:
the vectors z⁺ and z⁻ are obtained by respectively applying max(zᵥ, 0) and min(zᵥ, 0) elementwise to a vector z defined by

$${z}_{v} = {W}_{v , r}^{( i )} - \frac{{W}_{v , q}^{( i )} {W}_{1 , r}^{( i )}}{{W}_{1 , q}^{( i )}}$$

where W_{v,r}⁽ⁱ⁾ is the weight of the connection from node n_{i-1,v} to node n_{i,r} (so W_{1,r}ⁱ is the weight of the connection from node n_{i-1,1} to node n_{i,r});
the operator · is the vector dot product; and
the vectors equpᵢ₋₁ and eqlowᵢ₋₁ are respectively vectors of the upper and lower linear function bounds eqlow_{i-1,l} and equp_{i-1,l} of the nodes n_{i-1,l} in layer i−1.

Then, for each node n_{i,r}, conditional lower and upper concrete bounds \hat{l}_{i,r|q=0} and û_{i,r|q=0} on the pre-activation of n_{i,r} given that the pre-activation of node n_{i,q} is equal to zero may be obtained based on the linear function bounds [symbol] low_{i,r|q|0} and [symbol] up_{i,r|q=0}, for example by performing a linear optimisation over all neural network inputs reachable by the class of transformations obtained at step 110. Specifically, these concrete lower and upper bounds may be obtained as

$${\hat{l}}_{i , r \vert q = 0} = {min}_{{x}_{0}} {low}_{i , r \vert q = 0} ( {x}_{0} ) = {min}_{{x}_{0}} {z}^{-} \cdot {equp}_{i - 1} ( {x}_{0} ) + {z}^{+} \cdot {eqlow}_{i - 1} ( {x}_{0} )$$

$${\hat{u}}_{i , r \vert q = 0} = {max}_{{x}_{0}} {up}_{i , r \vert q = 0} ( {x}_{0} ) = {max}_{{x}_{0}} {z}^{+} \cdot {equp}_{i - 1} ( {x}_{0} ) + {z}^{-} \cdot {eqlow}_{i - 1} ( {x}_{0} )$$

Similarly, conditional lower and upper concrete bounds \hat{l}_{i,q|r=0} and û_{i,q|r=0} on the pre-activation of node n_{i,q} given that the pre-activation of the node n_{i,r} is equal to zero may also be computed, using the same technique.

These conditional lower and upper concrete bounds may then be used to deduce whether introducing a node state constraint on n_{i,q} would induce a node state constraint on n_{i,r} and vice versa.

In particular:
If û_{i,r|q=0}<0 and û_{i,q|r=0}<0, then the inactive state of n_{i,r} depends on the active state of n_{i,q} (that is, a node state constraint constraining the pre-activation of n_{i,q} to be positive induces a node state constraint constraining the pre-activation of n_{i,r} to be negative), and inversely, the inactive state of n_{i,q} depends on the active state of n_{i,r}.
If û_{i,r|q=0}<0 and \hat{l}_{i,q|r=0}>0, then the inactive state of n_{i,r} depends on the inactive state of n_{i,q}, and inversely, the active state of n_{i,q} depends on the active state of n_{i,r}.
If \hat{l}_{i,r|q=0}>0 and \hat{l}i,q|r=0>0, then the active state of n_{i,r} depends on the inactive state of n_{i,q}, and inversely, the active state of n_{i,q} depends on the inactive state of n_{i,r}.
If \hat{l}_{i,r|q=0}>0 and û_{i,q|r=0}<0, then the active state of n_{i,r} depends on the active state of n_{i,q}, and inversely, the inactive state of n_{i,q} depends on the inactive state of n_{i,r}.

For example, in the example of FIG. 2, although [\hat{l}_{1,1};û_{1,1}]=[−1.5; 4] and [\hat{l}_{1,2};û_{1,2}]=[−3;0.5], such that both nodes n_{1,1} and n_{1,2} are potentially unstable, the conditional lower and upper bounds \hat{l}_{1,1|,2=0}, û_{1,1|2=0}, \hat{l}_{1,2|=0} and û_{1,2|1=0} can be obtained as

$${\hat{l}}_{1 , 1 \vert 2 = 0} = {min}_{{x}_{0}} {z}^{-} \cdot {equp}_{0} ( {x}_{0} ) + {z}^{+} \cdot {eqlow}_{0} ( {x}_{0} ) = {min}_{{x}_{0}} 3 \cdot {x}_{0 , 2} = 1.5$$

$${\hat{u}}_{1 , 1 \vert 2 = 0} = {max}_{{x}_{0}} {z}^{+} \cdot {equp}_{0} ( {x}_{0} ) + {z}^{-} \cdot {eqlow}_{0} ( {x}_{0} ) = {max}_{{x}_{0}} 3 \cdot {x}_{0 , 2} = 6$$

$$since here z = ( {W}_{1 , 1}^{( 1 )} - \frac{{W}_{1 , 2}^{( 1 )} {W}_{1 , 1}^{( 1 )}}{{W}_{1 , 2}^{( 1 )}} , {W}_{2 , 1}^{( 1 )} - \frac{{W}_{2 , 2}^{( 1 )} {W}_{1 , 1}^{( 1 )}}{{W}_{1 , 2}^{( 1 )}} ) = ( 0 , 3 )$$

$$and$$

$${\hat{l}}_{1 , 2 \vert 1 = 0} = {min}_{{x}_{0}} {z}^{-} \cdot {equp}_{0} ( {x}_{0} ) + {z}^{+} \cdot {eqlow}_{0} ( {x}_{0} ) = {min}_{{x}_{0}} ( - 1 \text{.5} ) \cdot {x}_{0 , 2} = - 1.5$$

$${û}_{1 , 2 \vert 1 = 0} = {max}_{{x}_{0}} {z}^{+} \cdot {equp}_{0} ( {x}_{0} ) + {z}^{-} \cdot {eqlow}_{0} ( {x}_{0} ) = {max}_{{x}_{0}} ( - 1 \text{.5} ) \cdot {x}_{0 , 2} = - 0 \text{.75}$$

$$since here z = ( {W}_{1 , 2}^{( 1 )} - \frac{{W}_{1 , 1}^{( 1 )} {W}_{1 , 2}^{( 1 )}}{{W}_{1 , 1}^{( 1 )}} , {W}_{2 , 2}^{( 1 )} - \frac{{W}_{2 , 1}^{( 1 )} {W}_{1 , 2}^{( 1 )}}{{W}_{1 , 1}^{( 1 )}} ) = ( 0 , - 1.5 )$$

Thus, since \hat{l}_{1,1|2=0}>0 and û_{1,2|1}=₀≤0, it follows that the active state of n_{1,1} depends on the active state of n_{1,2}, and inversely, the inactive state of n_{1,2} depends on the inactive state n_{2,1}, as shown by the dotted arrow from \hat{x}_{1,1} to \hat{x}_{1,2} on FIG. 2.

In a second approach, given a candidate node state constraint which constrains a node n_{i,q} to be inactive, selected from the set of candidate node state constraints, the method may attempt to induce further node state constraints in the layer which follows the node n_{i,q} (that is, in layer i+1).

To do so, the method may determine how lower and upper bounds on the pre-activation of an unstable node n_{i+1,r} in the following layer change when the node n_{i,q} is constrained to be inactive. Indeed, when a ReLU node n_{i,q} is constrained to be inactive, the output of n_{i,q} becomes zero, which has an impact on the pre-activation of node n_{i+1,r} in the following layer. If lower and upper bounds on the pre-activation of node n_{i+1,r} change such that the pre-activation of node n_{i+1,r} is guaranteed to be wholly positive when n_{i,q} is constrained to be inactive, that means that the active state of n_{i+1,r} depends on the inactive state of n_{i,q}; conversely, if the pre-activation of node n_{i+1,r} is guaranteed to be wholly negative, then the inactive state of n_{i+1,r} depends on the inactive state of n_{i,q}.

To this end, lower and upper linear function bounds eqlow_{i,l} and equp_{i,l} may be obtained for the outputs of the nodes n_{i,j} in the same layer as the node n_{i,q} (that is, layer i). In addition, lower and upper linear function bounds [symbol] low_{i+1,r} and [symbol] up_{i+1,r} may be obtained for the pre-activation of node n_{i+1,r}.

When node n_{i,q} is constrained to be inactive, then the upper linear function bound of the pre-activation of node n_{i+1,r} becomes [symbol] up_{i+1,r}−(Wᵢ₊₁)_{r,q}·equp_{i,q}, and the lower linear function bound of the pre-activation of node n_{i+1,r} becomes [symbol] low_{i+1,r}−(Wᵢ₊₁)_{r,q}·eqlow_{i,q}. Therefore, the numerical range of the pre-activation of node n_{i+1,r} becomes wholly negative (and therefore the inactive state of n_{i+1,r} depends on the inactive state of n_{i,q}) if the concrete upper bound of [symbol] low_{i+1,r}−(Wᵢ₊₁)_{r,q}·eqlow_{i,q} over its domain is less than or equal to zero. Similarly, the numerical range of the pre-activation of node n_{i+1,r} becomes wholly positive (and therefore the active state of n_{i+1,r} depends on the inactive state of n_{i,q}) if the concrete lower bound of, [symbol] up_{i+1,r}−(Wᵢ₊₁)_{r,q}·equp_{i,q} over its domain is greater than or equal to zero.

This process of finding node state constraints induced in the following layer by a node state constraint on node n_{i,q} may be repeated for several or all of the unstable nodes n_{i+1,r} in layer i+1, thus yielding a set of zero or more induced state constraints.

Thus, in the example network of FIG. 2, the active state of n_{2,1} and the inactive state of n_{2,2} both depend on the inactive state of n_{1,2}. Furthermore, the inactive states of n_{3,1} and n_{3,2} both depend on the inactive state of n_{2,1}, as shown by the dashed arrows between these states in FIG. 2.

Advantageously, by using symbolic bounds (i.e. the lower and upper linear function bounds) on the pre-activations and outputs of the nodes in the network, rather than concrete bounds, in order to determine dependencies between node state constraints, finer bounds on these pre-activations and outputs may be obtained, therefore enabling dependencies to be identified which otherwise might not have been identified. As previously explained, the greater the number of identified dependencies, the greater the reduction in difficulty in the child verification problems.

At step 132a, having at step 131a determined dependencies between candidate node state constraints, one or more nodes are selected for which to create node state constraints to introduce into child verification problems.

In particular, for one or more nodes of the neural network, a dependency degree may be calculated. The dependency degree of a node n_{i,q} is the total number of further node state constraints that would be induced by complementary node state constraints that may be introduced for node n_{i,q}. For example, the dependency degree of n_{i,q} may be calculated as the number of further node state constraints which were determined to be induced by the candidate node state constraint constraining node n_{i,q} to be active, plus the number of further node state constraints which were determined to be induced by the candidate node state constraint constraining node n_{i,q} to be inactive. Such a dependency degree measures the total reduction in the number of integer variables across the two child verification problems which would result from introducing node state constraints for node n_{i,q}, and therefore reflects the reduction in complexity in the child verification problems compared to the original verification problem.

To calculate the dependency degree of one or more nodes, a dependency graph may be constructed, with the candidate node state constraints as the nodes of the graph, and with the identified dependencies between candidate node state constraints as the directed edges of the graph. That is, there is a directed edge in the dependency graph from a first candidate node state constraint to a second candidate node state constraint, if the second candidate node state constraint would be induced if the first candidate node state constraint were to be introduced into the verification problem. The dependency degree of a node n_{i,q} may then be computed as the combined total number of nodes in the dependency graph that are reachable from the constraint “n_{i,q} is active”, plus those that are reachable from the constraint “n_{i,q} is inactive”.

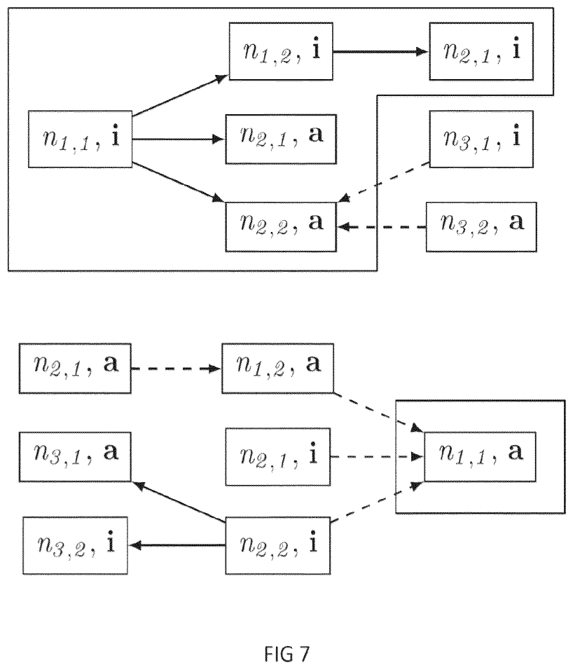

FIG. 7 illustrates the dependency graph obtained for the network of FIG. 2, where each vertex in the dependency graph is a pair (n_{i,v},s) which defines a candidate node state constraint, constraining the node n_{i,v} to state s, where s can be either the active state denoted a or the inactive state denoted i, and an edge from vertex (n_{i,v},s) to vertex (n_{j,u},s′) represents that the s′ state of node n_{j,u} depends on the s state of node n_{i,v}. Dashed edges indicate symmetric dependencies of the ones represented by solid edges. The rectangles highlight the nodes in the dependency graph that are reachable from the constraints “n_{1,1} is inactive” and “n_{1,1} is active” respectively. As can be seen, node n_{1,1} has the highest dependency degree of 6.

Returning to step 132a of FIG. 6, based on the determined dependency degrees, one or more nodes may be selected for introducing node state constraints. For example, the node with the highest dependency degree may be selected, which may lead to two child verification problems, one with the constraint that the node is active, and incorporating any additional constraints induced by that constraint, and the other with the constraint that the node is inactive, and incorporating any additional constraints induced by that constraint. A plurality of nodes with highest dependency degrees may be selected; for k selected nodes this would lead to 2^{k} child verification problems.

Turning to FIG. 8, a second example implementation of step 130 is described, which comprises steps 131b-133b. In this second example implementation, node pre-activation constraints are chosen which attempt to reduce the bounds on the range of pre-activations of nodes, calculated using Symbolic Interval Propagation (SIP), in an optimal manner.

At step 131b, lower and upper symbolic bounds [symbol] low_{j,u}(x₀) and [symbol] up_{j,u}(x₀) on the pre-activation of each node n_{j,u}, and lower and upper symbolic bounds eqlow_{j,u}(x₀) and equp_{j,u}(x₀) on the output of each node n_{j,u} may be obtained in terms of the input to the neural network x₀, as outlined above with reference to step 130 of FIG. 1. For example, these may be obtained by way of a SIP computation as outlined with reference to step 130 of FIG. 1 and FIG. 4. In particular, the SIP computation may be an Error-based Symbolic Interval Propagation, as described with reference to FIG. 4.

In addition to this, for each pair of nodes n_{i,v} and n_{j,u} such that n_{j,u} is in a layer subsequent to n_{i,v}, the SIP approximation error ϵ_{v,u}^{i,j} from node n_{i,v} at node n_{j,u} may be obtained, which represents the contribution of the uncertainty introduced by approximating the activation function of node n_{i,v} into a lower and upper linear function bound to the total uncertainty for the pre-activation of the subsequent node n_{j,u}. The SIP approximation error ϵ_{v,u}^{i,j} from node n_{i,v} at node n_{j,u} may for example be obtained by propagating the SIP approximation error ϵᵥⁱ obtained for a node n_{i,v} through the network all the way to node n_{j,u}, that is, by applying the weighted linear combinations defined by the network from node n_{i,v} to node n_{j,u}. Formally speaking, each term ϵ_{v,u}^{i,j} may be obtained through the inductive relationship

$$\{ \begin{matrix}{ϵ}_{v , s}^{i , i + 1} = {W}_{v , s}^{i + 1} {ϵ}_{v}^{i} \\ {ϵ}_{v , t}^{i , h + 1} = {\sum }_{s} {W}_{s , t}^{h + 1} {a}_{s}^{h} {ϵ}_{v , s}^{i , h} for any h \geq i + 1\end{matrix}$$

or a mathematical equivalent, where W_{s,t}^{h+1} is the weight from node n_{h,s} to node n_{h+1,t} and aₛ^{h} is the slope of the lower linear function bound actlow_{h,s}(x_{h,s}) of the activation of node n_{h,s}. The SIP approximation error ϵᵥⁱ at a node n_{i,v}, which represents the distance between the lower and upper linear function bounds eqlow_{i,v}(x₀) and equp_{i,v}(x₀) on the output of node n_{i,v}, may itself be obtained from those lower and upper linear function bounds eqlow_{i,v}(x₀) and equp_{i,v}(x₀) as

$${ϵ}_{v}^{i} = {max}_{{x}_{0}} ( {equp}_{i , v} ( {x}_{0} ) - {eqlow}_{i , v} ( {x}_{0} ) ) .$$

Alternatively, if an Error-based Symbolic Interval Propagation was used, the SIP approximation errors ϵ_{v,u}^{i,j} from node n_{i,v} at node n_{j,u} may be obtained simply as a by-product of the ESIP process, as previously explained with reference to FIG. 4.

Having obtained for each pair of nodes n_{i,v} and n_{j,u} such that n_{j,u} is in a layer subsequent to n_{i,v} the SIP approximation error ϵ_{v,u}^{i,j} from node n_{i,v} at node n_{j,u}, it is then the case that the uncertainty in the SIP bounds for the pre-activation of a node n_{j,u}, that is, the maximum distance between the upper and lower bounds on the pre-activation of n_{j,u}, can be expressed as

$${max}_{{x}_{0}} ( {up}_{j , u} ( {x}_{0} ) {low}_{j , u} ( {x}_{0} ) ) = {\sum }_{i = 0}^{j - 1} {\sum }_{v} \vert {ϵ}_{v , u}^{i , j} \vert$$

Furthermore, when the lower linear function bound used to approximate the activation function at each node has no constant term (as is the case for the ReLU activation function), then the lower and upper linear function bounds on the pre-activation of n_{j,u} are both of the form

[symbol]

low_{j,u}(x₀)=qᵤ^{j}(x₀)+Σᵢ₌₀^{j-1}Σ_{v|ϵ}_{_{v,u}}_{^{i,j}}_{≤0}ϵ_{v,u}^{i,j}

[symbol]

up_{j,u}(x₀)=qᵤ^{j}(x₀)+Σᵢ₌₀^{j-1}Σ_{v|ϵ}_{_{v,u}}_{^{i,j}}_{≥0}ϵ_{v,u}^{i,j}

where qᵤ^{j}(x₀) is a linear function.

Denoting l the number of layers in the neural network, such that layer l is the output layer of the network and the pre-activations x_{l,k} of the nodes n_{i,k} in layer l constitute the output of the network, the expressions [symbol] low_{l,k}(x₀) and [symbol] up_{l,k}(x₀) therefore provide lower and upper linear function bounds on the k-th component of the output of the network.

(If, unusually, the nodes in the final layer apply an activation function to their pre-activations, the network may be extended with an additional layer, with weights chosen according to a one-hot encoding, such that the pre-activations of the additional layer are equal to the outputs of the final layer, and the additional layer considered to be the final layer.)

Therefore the maximum distance Dₖ between the lower and upper bounds [symbol] low_{l,k}(x₀) and [symbol] up_{l,k}(x₀) on the k-th component of the neural network output may be expressed in terms of the SIP approximation errors ϵ_{v,k}^{i,l} from every node n_{i,v} that is not in the output layer of the network to node n_{l,k}. For example, Dₖ may be expressed as

$${D}_{k} = {max}_{{x}_{0}} ( {up}_{l , k} ( {x}_{0} ) - {low}_{l , k} ( {x}_{0} ) ) = {\sum }_{i = 0}^{l - 1} {\sum }_{v} \vert {ϵ}_{v , k}^{i , l} \vert$$

Moreover, if the lower linear function bound used to approximate the activation function at each node has no constant term (for example, if the ReLU activation function is used), then lower and upper linear function bounds Lₖ(x₀) and Uₖ (x₀) on the k-th component of the output of the neural network can also be expressed in terms of the SIP approximation errors ϵ_{v,k}^{i,j} from every node n_{i,v} that is not in the output layer of the network to node n_{l,k}. For example, Lₖ and Uₖ may be expressed as

Lₖ(x₀)= [symbol] low_{l,k}(x₀)=qₖ^{l}(x₀)+Σᵢ₌₀^{l-1}Σ_{v|ϵ}_{_{v,k}}_{^{i,l}}_{≤0}ϵ_{v,k}^{i,l}

Uₖ(x₀)= [symbol] up_{l,k}(x₀)=qₖ^{l}(x₀)+Σᵢ₌₀^{l-1}Σ_{v|ϵ}_{_{v,k}}_{^{i,l}}_{≥0}ϵ_{v,k}^{i,l}

where qᵤ^{j}(x₀) is a linear function.

Thus, as can be seen from these relations, the range of the SIP-estimated bounds on the output of the neural network can be quantified in terms of the SIP approximation error terms ϵ_{v,u}^{i,j} from every node n_{i,v} that is not in the output layer to every node n_{l,k} in the output layer.

At step 132b, for each of one or more node pre-activation constraints which can be introduced into the verification problem, the reduction in the SIP-estimated bound on the range of each component of the output of the neural network may be estimated.

Advantageously, because the present disclosure enables the range of each component of the output of the neural network to be expressed in terms of the SIP approximation error terms ϵ_{v,u}^{i,j} from every node n_{i,v} that is not in the output layer to every node n_{l,k} in the output layer, the effects of introducing a node pre-activation constraint on the ranges of the components of the output may be quantified by determining the changes in the SIP approximation error terms ϵ_{v,u}^{i,j} that would be induced by the new node pre-activation constraint.

First of all, introducing a node pre-activation constraint on a node n_{i,v} has a direct effect of reducing the domain over which the activation function operates, thus enabling tighter lower and upper linear function bounds to be constructed for the node's activation function, such as the bounds actlow_{i,v}(\hat{x}_{i,v}) and actup_{i,v}(\hat{x}_{i,v}) of step 440 of the SIP process of FIG. 4. Therefore, the SIP approximation error=

$${ϵ}_{v}^{i} = {max}_{{x}_{0}} ( {equp}_{i , v} ( {x}_{0} ) - {eqlow}_{i , v} ( {x}_{0} ) )$$

is reduced accordingly, which has a proportional effect on the SIP approximation error terms ϵ_{v,u}^{i,j} arising from node n_{i,v} and therefore on the ranges of the components of the neural network output. For example, for a node n_{i,v} whose activation function is a ReLU, introducing a constraint on the pre-activation i, such that \hat{x}_{i,v}≤0 or such that \hat{x}_{i,v}≥0 leads to both lower and upper linear function bounds on the activation function to become identical, actlow_{i,v}(\hat{x}_{i,v})=actup_{i,v}(\hat{x}_{i,v})=0 in the case \hat{x}_{i,v}≤0, and actlow_{i,v}(\hat{x}_{i,v})=actup_{i,v}(\hat{x}_{i,v})=\hat{x}_{i,v} in the case \hat{x}_{i,v}≥0. Thus, as a result of introducing the node pre-activation constraint, both the SIP approximation error ϵᵥⁱ introduced at n_{i,v} and the SIP approximation errors ϵ_{v,u}^{i,j} from node n_{i,v} at any subsequent node n_{j,u} become equal to zero, thus causing a corresponding reduction in the estimated ranges of the components of the network output. In other words, introducing a node pre-activation constraint at node n reduces the range of each component k of the network output by ϵ_{v,k}^{i,l}, by virtue of the tighter bounds actlow_{l,v}(\hat{x}_{i,v}) and actup_{l,v}(\hat{x}_{i,v}) obtained.

In this manner, a measure r_{u,dir}^{j}(n_{i,v}) of the reduction in range of the pre-activation \hat{x}_{j,u} of a node n_{j,u} caused by the direct effect of introducing a node pre-activation constraint at node n_{i,v} can be obtained. The reduction in range of component k of the output of the network is then given by r_{k,dir}^{l}(n_{i,v}). In particular, for a node n_{i,v} with a ReLU activation function, the reduction can be expressed as r_{u,dir}^{j}(n_{i,v})=ϵ_{v,u}^{i,j}.

Furthermore, introducing a node pre-activation constraint on a node n_{i,v} because it leads to tighter lower and upper linear function bounds actlow_{i,v}(\hat{x}_{i,v}) and actup_{i,v}(\hat{x}_{i,v}) being constructed for n_{i,v}'s activation function, has the indirect effect of enabling tighter linear function bounds to be obtained for the pre-activations of the nodes n_{i+1,u} in the following layer, which reduces the domains over which the activation functions in the next layer operate, enabling more precise lower and upper linear function bounds actlow_{i+1,u}(x_{i+1,u}) and actup_{i+1,u}(\hat{x}_{i+1,u}) to be constructed for the activation functions of the nodes n_{i+1,u}. In turn, this enables more precise lower and upper linear function bounds to be obtained for the pre-activations of the nodes n_{i+2,t} in the layer after, and therefore more precise lower and upper linear function bounds actlow_{i+1,u}(\hat{x}_{i+1,u}) and actup_{i+1,u}(\hat{x}_{i+1,u}) to be constructed for the activation functions of that layer, and so forth. In other words, not only are the SIP approximation errors ϵᵥⁱ reduced by the node pre-activation constraint on a node n_{i,v} but also the SIP approximation errors at the next layer ϵᵤⁱ⁺¹, those at the subsequent layer ϵₜⁱ⁺², and so forth.

Thus, the indirect effect at a node n_{i+1,u} of introducing a node pre-activation constraint at a node n_{i,v} in the previous layer is the direct effect of the reduction of the range of the pre-activation of node n_{i+1,u} caused by the direct effect of the node pre-activation constraint at node n_{i,v}.

Because of this, a measure r_{u,indir}^{j}(n_{i,v}) of the reduction in range of the pre-activation \hat{x}_{j,u} of a node n_{j,u} caused by the indirect effect of introducing a node pre-activation constraint at a preceding node n_{i,v} can be computed recursively. Specifically, if introducing a node pre-activation constraint at a node n_{i,v} removes a fraction α_{v,u}^{i,i+1}∈[0;1] of the error ϵᵤⁱ⁺¹ at the pre-activation \hat{x}_{i+1,u} of a node n_{i+1,u} in the following layer, then for a node n_{i+2,t} in layer i+2, the reduction r_{t,indir}ⁱ⁺²(n_{i,v}) is well-estimated by

r_{t,indir}ⁱ⁺²(n_{i,v})=Σᵤα_{v,u}^{i,i+1}r_{u,dir}ⁱ⁺¹(n_{i,v})

The fraction α_{v,u}^{i,i+1}∈[0;1] can be estimated as follows in the case where the activation functions of the nodes are ReLUs. This error is completely removed if the concrete lower bound

$${\hat{l}}_{i + 1 , u} = {min}_{{x}_{0}} {low}_{i + 1 , u} ( {x}_{0} )$$

is larger than 0, or if the upper bound

$${û}_{i + 1 , u} = {max}_{{x}_{0}} {up}_{i + 1 , u} ( {x}_{0} )$$

is less than 0. Therefore, reducing the interval width [\hat{l}_{i+1,u};û_{i+1,u}] by wᵤⁱ⁺¹+1=2 min(|\hat{l}_{i+1,u}|,|û_{i+1,u}|) reduces the error ϵᵤⁱ⁺¹ at node n_{i+1,u} to zero. Since the SIP approximation error ϵ_{v,u}^{i,i+1} from node n_{i,v} to node n_{j,u} affects the lower and upper linear function bounds, e.g. according to the formulae

[symbol]

low_{i+1,u}(x₀)=qᵤⁱ⁺¹(x₀)+Σⱼ₌₀ⁱΣ_{v|ϵ}_{_{v,u}}_{^{j,i+1}}_{≤0}ϵ_{v,u}^{j,i+1}

[symbol]

up_{i+1,u}(x₀)=qᵤⁱ⁺¹(x₀)+Σⱼ₌₀ⁱΣ_{v|ϵ}_{_{v,u}}_{^{j,i+1}}_{≥0}ϵ_{v,u}^{j,i+1}

it follows that the term ϵ_{v,u}^{i,i+1} either augments the lower concrete bound \hat{l}_{i+1,u} or the upper concrete bound û_{i+1,u}. Therefore, introducing a node pre-activation constraint to fix the pre-activation of node n_{i,v} to be positive or negative reduces the interval [\hat{l}_{i+1,u};û_{i+1,u}]'s width by approximately |ϵ_{v,u}^{i,i+1}|. Therefore, the fraction α_{v,u}^{i,i+1} the error ϵᵤⁱ⁺¹ at the pre-activation \hat{x}_{i+1,u} of a node n_{i+1,u} removed as an indirect effect of the node pre-activation constraint at node n_{i,v} is given by α_{v,u}^{i,i+1}=|ϵ_{v,u}^{i,i+1}|/wᵤⁱ⁺¹, and the resulting reduction r_{t,indir}ⁱ⁺²(n_{i,v}) in range of the pre-activation of a node n_{i+2,t} is given by

r_{t,indir}ⁱ⁺²(n_{i,v})=Σᵤ|ϵ_{v,u}^{i,i+1}|/wᵤⁱ⁺¹·r_{u,dir}ⁱ⁺¹(n_{i,v})

Finally, using the same reasoning, the reduction r_{u,indir}^{j}(n_{i,v}) in range of the pre-activation x_{j,u} of a node n_{j,u} caused by the indirect effect of introducing a node pre-activation constraint at a preceding node n_{i,v} can be computed recursively as

$${r}_{u , indir}^{j} ( {n}_{i , v} ) = {\sum }_{h = i + 1}^{j - 1} {\sum }_{t} {α}_{v , t}^{i , h} {r}_{u}^{j} ( {n}_{h , t} ) = {\sum }_{h = i + 1}^{j - 1} {\sum }_{t} \vert {ϵ}_{v , t}^{i , h} \vert / {w}_{t}^{h} \cdot {r}_{u}^{j} ( {n}_{h , t} )$$

$$where$$

$${r}_{u}^{j} ( {n}_{i , v} ) = {r}_{u , dir}^{j} ( {n}_{i , v} ) + {r}_{u , indir}^{j} ( {n}_{i , v} )$$

In some implementations, because of the approximate nature of the estimation of the α_{v,t}^{i,h} terms, the term r_{u,indir}^{j}(n_{i,v}) may be given less weight in the above equation, e.g. with a weighting factor β∈[0;1], such as in

rᵤ^{j}(n_{i,v})=r_{u,dir}^{j}(n_{i,v})+β·r_{u,indir}^{j}(n_{i,v})

Experimentally, the value β=⅔ performs well to balance the two components.

The total reduction in range rᵤ^{j}(n_{i,v}) of the pre-activation \hat{x}_{j,u} of a node n_{j,u} caused by the combination of the direct and indirect effects of introducing a node pre-activation constraint at node n_{i,v} can thus be obtained from the recursive set of equations

$$\{ \begin{matrix}{r}_{u , dir}^{j} ( {n}_{i , v} ) := {ϵ}_{v , u}^{i , j} \\ {r}_{u , indir}^{j} ( {n}_{i , v} ) := {\sum }_{h = i + 1}^{j - 1} {\sum }_{t} \vert {ϵ}_{v , t}^{i , h} \vert / {w}_{t}^{h} \cdot {r}_{u}^{j} ( {n}_{h , t} ) \\ {r}_{u}^{j} ( {n}_{i , v} ) := {r}_{u , dir}^{j} ( {n}_{i , v} ) + β \cdot {r}_{u , indir}^{j} ( {n}_{i , v} )\end{matrix}$$

The value rᵤ^{j}(n_{i,v}) can then be computed for j=l and u=k to obtain the reduction in range of component k of the output of the network as a result of introducing a node pre-activation constraint at node n_{i,v}.

Alternatively, instead of computing a reduction rₖ^{l}(n_{i,v}) in the range of the pre-activation of an output \hat{x}_{l,k} of the network when introducing a node pre-activation constraint at a node n_{i,v} a score metric s(n_{i,v}) may be determined which measures how much an output constraint is brought nearer to being proven. In particular, given an output constraint in the form of a linear inequality a^{T}\hat{x}ₗ+b≤0, a score metric s(n_{i,v}) may be determined that measures the extent to which a bound on the linear function a^{T}\hat{x}₁+b which is constrained by the linear inequality, is reduced when introducing a node pre-activation constraint at the node n_{i,v}.

Indeed, the function gᵤₚ(\hat{x}₀)=Σ_{k|a}_{ₖ}_{>}0Uₖ(x₀)aₖ+Σ_{k|a}_{ₖ}_{<0}Lₖ(x₀)aₖ+b is an upper bound for a^{T}\hat{x}ₗ+b, where the functions Lₖ(x₀) and Uₖ(x₀) are respectively lower and upper symbolic bounds on the k-th component of the output of the neural network, \hat{x}_{l,k}, defined by Lₖ(x₀)= [symbol] low_{l,k}(x₀) and Uₖ(x₀)= [symbol] up_{l,k}(x₀). In particular, where the activation functions of the neural network are ReLUs, the functions Lₖ and Uₖ satisfy

Lₖ(x₀)=qₖ^{l}(x₀)+Σᵢ₌₀ⁱ⁻¹Σ_{v|ϵ}_{_{v,k}}_{^{i,l}}_{≤0}ϵ_{v,k}^{i,l}

Uₖ(x₀)=qₖ^{l}(x₀)+Σᵢ₌₀ⁱ⁻¹Σ_{v|ϵ}_{_{v,k}}_{^{i,l}}_{≥0}ϵ_{v,k}^{i,l}

Thus, since negative SIP approximation error terms ϵ_{v,k}^{i,l} are added to Lₖ(x₀), and positive error terms ϵ_{v,k}^{i,l} are added to Uₖ (x₀), it follows that the reduction in gᵤₚ(\hat{x}₀) from the direct effect of introducing a node pre-activation constraint on n_{i,v} is equal to

s_{dir}(n_{i,v})=Σ_{k|ϵ}_{_{v,k}}_{^{i,l}}_{>0 and a}_{ₖ}_{>0}ϵ_{v,k}^{i,l}aₖ+Σ_{k|ϵ}_{_{v,k}}_{^{i,l}}_{<0 and a}_{ₖ}_{<0}ϵ_{v,k}^{i,l}aₖ

Using the same inductive reasoning as previously to estimate the indirect effect of introducing a node pre-activation constraint on n_{i,v} on the reduction in gᵤₚ(\hat{x}₀) as a proportion of the direct effects from other nodes, the total reduction in gᵤₚ(\hat{x}₀) occasioned by introducing a node pre-activation constraint on n_{i,v} can be estimated using the recursive equations:

$$\{ \begin{matrix}{s}_{dir} ( {n}_{i , v} ) := {\sum }_{k \vert {ϵ}_{v , k}^{i , l} > 0 and {a}_{k} > 0} {ϵ}_{v , k}^{i , l} {a}_{k} + {\sum }_{k \vert {ϵ}_{v , k}^{i , l} < 0 and {a}_{k} < 0} {ϵ}_{v , k}^{i , l} {a}_{k} \\ {s}_{indir} ( {n}_{i , v} ) := {\sum }_{h = i + 1}^{l - 1} {\sum }_{t} \vert {ϵ}_{v , t}^{i , h} \vert / {w}_{t}^{h} \cdot s ( {n}_{h , t} ) \\ s ( {n}_{i , v} ) := {s}_{dir} ( {n}_{i , v} ) + β \cdot {s}_{indir} ( {n}_{i , v} )\end{matrix}$$

Advantageously, as a result of the present disclosure's understanding of a newly-introduced node pre-activation constraint's direct effect and indirect effect on the outputs of the neural network, it thus becomes possible to determine one or more node pre-activation constraints which affect the range of the network output in whichever manner desired by the user (e.g. one or more node pre-activation constraints which maximally reduce the ranges of the components of the network output; or which reduce the range of the components of the network output in such a way as to most effectively attempt to prove a transformational robustness property). Further beneficially, the present disclosure enables these effects to be estimated accurately and without requiring a further SIP calculation to be performed with the node pre-activation constraint to be introduced, which enables an optimal search for one or more most promising node pre-activation constraints to be conducted in a computationally efficient manner.

Consequently, the reduction rₖ^{l}(n_{i,v}) in range of component k of the output of the network as a result of introducing a node pre-activation constraint at node n_{i,v} may be computed for a plurality of candidate node pre-activation constraints. Beneficially, for networks with ReLU activation functions, the candidate node pre-activation constraints may be one or more pairs of complementary node state constraints, as node state constraints (node pre-activation constraints which constrain a node's pre-activation to be positive or to be negative) lead to the largest reduction in SIP approximation error for ReLU activation functions. For other activation functions, other candidate node pre-activation constraints may be evaluated.

At step 133b, having obtained the reduction rₖ^{l}(n_{i,v}) in range of component k of the output of the network as a result of introducing a node pre-activation constraint at node n_{i,v}, for each component k of the output, for one or more candidate node pre-activation constraints, one or more sets of complementary node pre-activation constraints may be selected to introduce in the verification problem. For example, one or more sets (e.g. pairs) of complementary node pre-activation constraints which maximally reduce the ranges of the components of the network output may be selected. As another example, one or more sets (e.g. pairs) of complementary node pre-activation constraints which reduce the ranges of the components of the neural network in a manner that most efficiently attempts to satisfy the output constraints obtained at step 110 may be selected. In general, one or more sets of complementary pre-activation constraints which affect the ranges of the components of the network output in whichever manner desired by the method's user may be selected. Additionally or alternatively, one or more sets of complementary node pre-activation constraints may be selected which make maximal progress towards proving one of, or a combination of multiple of, the output constraints obtained at step 110, byway of the score metrics s(n_{i,v}) which measure the extent to which a bound on a linear function a^{T}\hat{x}ₗ+b is reduced when introducing a node pre-activation constraint at the node n_{i,v}

We note that step 131b-133b significantly differs from previous approaches for selecting node pre-activation constraints. In particular, the method presented here takes into account both the direct and indirect effect, which may significantly improve the performance of said method. Moreover, the method utilises intermediate calculations from ESIP, and is thus computationally efficient.

FIG. 9 depicts an example method 160a for solving a child verification problem, comprising steps 161a-163a. Method 160a encodes the child verification problem as a set of algebraic constraints and determines whether the set admits a solution.

At step 161a, the child verification problem is expressed as a set of algebraic constraints, for which the existence of a solution indicates the existence of a counter-example to the transformational robustness property. Where the child verification problem consists of the original transformational robustness verification problem augmented by one or more node state constraints, the child verification problem may be expressed as a set of algebraic constraints, for example as described in WO 2020/109774A1, or in Kouvaros, Panagiotis and Lomuscio, Alessio. Formal Verification of CNN-based Perception Systems, arXiv:1811.11373. In addition to the encodings described in those documents for the class of transformations, convolutional operations, ReLU activation functions, max-pooling operations and output constraints, the ReLU activation functions of any node n_{j,u} which has been determined to be stable, or for which the child verification problem comprises an additional node state constraint (whether chosen to be introduced or induced by another node state constraint), may be encoded as follows:
if the node n_{j,u} is stable and always in the active state, or has a node state constraint to always be active, the node's activation function may be encoded into the algebraic constraint x_{j,u}=\hat{x}_{j,u};
if the node n_{j,u} is stable and always in the inactive state, or has a node state constraint to always be inactive, the node's activation function may be encoded into the algebraic constraint x_{j,u}=0. In addition, if n_{j,u} admits a node state constraint which is one of the two complementary node state constraints introduced when generating child verification problems, the activation function may be represented by an additional constraint \hat{x}_{j,u}≤0;
if the node n_{j,u} was neither determined to be stable nor has a node state constraint, then the node's activation function may be encoded into the set of algebraic constraints

$$\{ \begin{matrix}{x}_{j , u} \geq {\hat{x}}_{j , u} \\ {x}_{j , u} \leq {\hat{x}}_{j , u} - {\hat{l}}_{j , u} \cdot ( 1 - {δ}_{j , u} ) \\ {x}_{j , u} \leq {û}_{j , u} \cdot {δ}_{j , u}\end{matrix}$$

where \hat{l}_{j,u} and û_{j,u} are respectively lower an upper concrete bounds on the pre-activation \hat{x}_{j,u}, and δ_{j,u} is an additional (unknown) binary variable, that can take the value 0 or 1, and which represents whether the node is active or inactive.

Thus, if the neural network uses ReLU activation functions, the child verification problem may be expressed as a Mixed-Integer Linear Program (MILP).

At step 162a, it may be determined whether the set of algebraic constraints admits a solution. For example, if the set of algebraic constraints contains one or more binary variables, progress towards finding a solution may be made using a branch-and-bound algorithm, by iteratively solving tighter and tighter relaxations of the set of algebraic constraints where more and more of the binary variables are fixed to a definite value. For example, if the set of algebraic constraints is a Mixed-Integer Linear Program, a solution may be found by a branch-and-bound algorithm that iteratively solves tighter and tighter Linear Program (LP) relaxations of the MILP.

If a solution to the set of algebraic constraints is found at step 162a, this solution is a counter-example to the child verification problem and may therefore be returned at step 163a. Otherwise, if it is determined that no solution to the set of algebraic constraints exists, the child verification problem may be discarded at step 164a.

FIG. 10 depicts another example method 160b for solving a child verification problem, comprising steps 161b-165b.

The principle underlying method 160b is that as a result of the additional constraints in the child verification problem (and particularly if those constraints were chosen using the method of FIG. 8), it may be that sufficiently refined bounds on the output can be obtained so as to altogether prove that the output constraints are always satisfied in the child verification problem, or at least to sufficiently reduce the space wherein a counter-example is determined to lie, such that a counter-example can be easily found by a search. If neither the output constraints can be proven to be always satisfied, nor a counter-example found, the child verification problem may itself be split into further child verification problems by introducing further additional constraints using steps 120-160 of FIG. 1, in an attempt to further refine the bounds on the network's output. The additional constraints may for example be chosen using the algorithm of FIG. 8, and may be selected so as to make maximal progress towards proving the output constraints which are not yet proven to be satisfied—for example, in the manner explained in step 133b of FIG. 8.

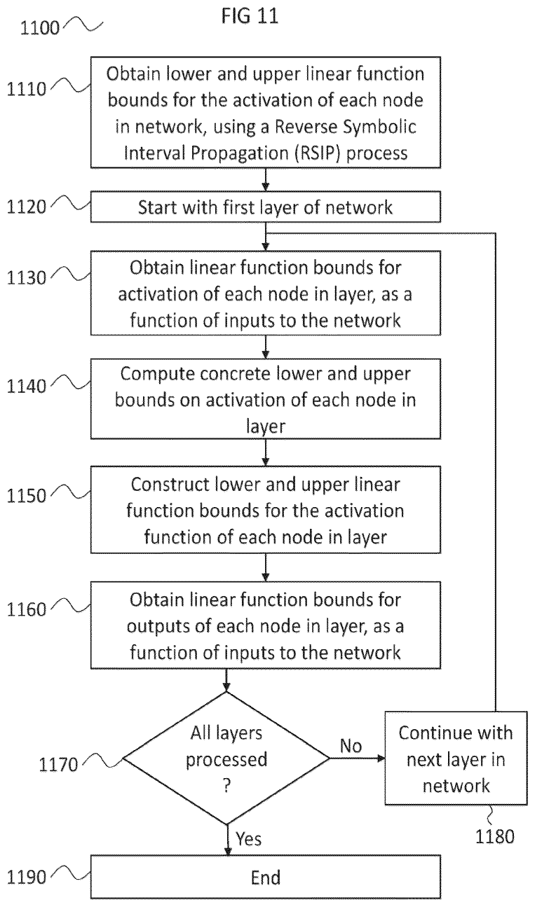

At step 161b, lower and upper symbolic bounds [symbol] low_{l,k}(x₀) and [symbol] up_{l,k}(\hat{x}₀) may be determined on the neural network output \hat{x}ᵢ in terms of the network input x₀. This may be achieved using any suitable process, including a Symbolic Interval Propagation process such as one of those described with reference to FIG. 4, or, even preferably, the improved Symbolic Interval Propagation process of FIG. 11, yielding lower and upper symbolic bounds [symbol] low_{l,k}^{rsip}(x₀) and [symbol] up_{l,k}^{rsip}(x₀) on the output of the neural network obtained through the RSIP process, and a linear function q_{l,k}(x₀) and a set of SIP approximation error terms ϵ_{v,k}^{i,l} obtained through the subsequent ESIP process, such that q_{l,k}(x₀)+Σ_{i,v|ϵ}_{_{v,k}}_{^{i,l}}_{<0}ϵ_{v,k}^{i,l}≤\hat{x}_{l,k}≤q_{l,k}(x₀)+Σ_{i,v|ϵ}_{_{v,k}}_{^{i,l}}_{>0}ϵ_{v,k}^{i,l}.

Additionally or alternatively, for each output constraint, which can be expressed in the form a^{T}\hat{x}ₗ+b≤0, a function \hat{ƒ}(x₀) may be defined that applies the transformation a^{T}\hat{x}ₗ+b to the function defined by the neural network. Since \hat{ƒ} is an affine transformation of the output of the neural network, \hat{ƒ} is itself a feed-forward neural network, so that the output constraint can be written as \hat{ƒ}(x₀)≤0. Thus, instead of determining lower and upper symbolic bounds on the output \hat{x}ₗ of the neural network, lower and upper symbolic bounds [symbol] low_{(\hat{ƒ})}(x₀) and [symbol] up_{(\hat{ƒ})}(x₀) may be obtained on the function \hat{ƒ}(x₀), since it itself is a neural network; this may for example be achieved using one or another of the SIP processes described above. For example, if using the improved Symbolic Interval Propagation process of FIG. 11 in this way, lower and upper symbolic bounds [symbol] low_{(\hat{ƒ})}^{rsip}(x₀) and [symbol] up_{(\hat{ƒ})}^{risp}(x₀) may be obtained such that [symbol] low_{(\hat{ƒ})}^{risp}(x₀)≤\hat{ƒ}(x₀)≤ [symbol] up_{(\hat{ƒ})}^{risp}(x₀), and a linear function q_{(\hat{ƒ})}(x₀) and error terms ϵ_{v,(\hat{ƒ})}ⁱ may be obtained such that lower and upper bounds [symbol] low_{(\hat{ƒ})}^{esip}(x₀) and [symbol] up_{(\hat{ƒ})}^{esip}(x₀) may be defined as

[symbol]

low_{(\hat{ƒ})}^{esip}(x₀)=q_{(\hat{ƒ})}(x₀)+Σ_{i,v|ϵ}_{_{v,(\hat{ƒ})}}_{ⁱ}_{<0}ϵ_{v,(\hat{ƒ})}ⁱ

[symbol]

up_{(\hat{ƒ})}^{esip}(x₀)=q_{(\hat{ƒ})}(x₀)+Σ_{i,v|ϵ}_{_{v,(\hat{ƒ})}}_{ⁱ}_{>0}ϵ_{v,(\hat{ƒ})}ⁱ

such that

[symbol]

low_{(\hat{ƒ})}^{esip}(x₀)≤\hat{ƒ}(x₀)≤ [symbol] up_{(\hat{ƒ})}^{esip}(x₀)

At step 162b, having obtained the lower and upper symbolic bounds [symbol] low_{l,k}(x₀) and [symbol] up_{l,k}(x₀), it may be determined whether the output constraints are satisfied. This may be achieved by constructing a set of algebraic constraints which any counter-example to the verification problem must satisfy, and determining whether a solution exists to this set of algebraic constraints.

For example, for an output constraint of the form a^{T}\hat{x}ₗ+b≤0, the quantity a^{T}\hat{x}ₗ+b is bounded from above by the expression

Σ_{k|a}_{ₖ}_{≤0}aₖ [symbol] low_{l,k}(x₀)+Σ_{k|a}_{ₖ}_{≥0}aₖ [symbol] up_{l,k}(x₀)+b

so that if no x₀ can be found that satisfies the inequality

Σ_{k|a}_{ₖ}_{≤0}aₖ [symbol] low_{l,k}(x₀)+Σ_{k|a}_{ₖ}_{≥0}aₖ [symbol] up_{l,k}(x₀)+b≥0

then the output constraint is satisfied. Conversely, if an x₀ can be found that satisfies the corresponding inequality for each output constraint, then this x₀ is potentially a counter-example to the verification problem.

Additionally or alternatively, the set of algebraic constraints may comprise the inequality \hat{ƒ}(x₀)≥0. In particular, if an upper bound [symbol] up_{(\hat{ƒ})}(x₀) has been obtained for \hat{ƒ}(x₀), the set of algebraic constraints may comprise [symbol] up_{(\hat{ƒ})}(x₀)≥0. For example, if an upper bound [symbol] up_{(\hat{ƒ})}^{rsip}(x₀) has been obtained for \hat{ƒ}(x₀) using a RSIP process as previously described with reference to FIG. 4, the set of algebraic constraints may comprise [symbol] up_{(\hat{ƒ})}^{rsip}(x₀)≥0. As another example, if an upper bound [symbol] up_{(\hat{ƒ})}^{esip}(x₀) has been obtained \hat{ƒ}(x₀) using a RSIP process as previously described with reference to FIG. 4, the set of algebraic constraints may comprise [symbol] up_{(\hat{ƒ})}^{esip}(x₀)≥0. As yet another example, if the improved Symbolic Interval Propagation process of FIG. 11 was used to obtain upper bounds [symbol] up_{(\hat{ƒ})}^{rsip}(x₀) and [symbol] up_{(\hat{ƒ})}^{esip}(x₀) on \hat{ƒ}(x₀), the set of algebraic constraints may comprise both

$$\{ \begin{matrix}{up}_{( \hat{f} )}^{rsip} ( {x}_{0} ) \geq 0 \\ {up}_{( \hat{f} )}^{esip} ( {x}_{0} ) \geq 0\end{matrix}$$

Additionally or alternatively, the set of algebraic constraints may comprise the set of constraints

$$\{ \begin{matrix}{y}_{( \hat{f} )}^{esip} ( {x}_{0} , σ ) \geq 0 \\ {σ}_{v}^{i} ∈ [ 0 ; 1 ] ∀ i , v\end{matrix}$$

or a mathematical equivalent, where the σᵥⁱ are auxiliary variables, one for each node in the network, and the expression y_{(\hat{ƒ})}^{esip}(x₀,σ) is defined as:

y_{(\vec{ƒ})}^{esip}(x₀,σ)=q_{(\hat{ƒ})}(x₀)+Σ_{i,v}σᵥⁱϵ_{v,(\vec{ƒ})}ⁱ

This formulation may enable node pre-activation constraints introduced by child verification problems to be easily expressed and included within the set of algebraic constraints, as will be explained further below with reference to step 166b. Furthermore, this formulation may enable the node pre-activation constraints to be formulated in a manner that ensures that the formulations of the various node pre-activation constraints nevertheless reflect the fact that for a given input, each node of the neural network has a single pre-activation value, which must be the same in the formulation of all pre-activation constraints, even though this value might not be precisely known due to the SIP approximation. This property is enforced by the single set of auxiliary variables σᵥⁱ, one for each node in the network.

Thus whether the output constraint is satisfied can be determined by attempting to find a solution to one of the above sets of inequality constraints (or a mathematical equivalent); for example, this may be done using a linear programming solver. If the inequality constraints admit no solution, then all the output constraints are satisfied and the child verification problem may be discarded at step 163b. However, if the inequality constraints admit a solution x₀^{(c/ex)}, then the solution is a potential counter-example and may be used as a starting point to search for a counter-example to the child verification problem at step 164b.

At step 164b, having obtained a solution x₀^{(c/ex)} which is a potential counter-example, a search is performed to attempt to find a counter-example to the verification problem. In particular, the search may be performed if the potential counter-example x₀^{(c/ex)} is not itself a counter-example. The search may be performed by gradient descent starting from the potential counter-example x₀^{(c/ex)} and using a loss function L(x)=−Σₙa⁽ⁿ⁾^{^{T}}ƒ(x₀^{(c/ex)}) where ƒ(x₀) is the function applied by the neural network, and each a⁽ⁿ⁾ corresponds to an inequality constraint of the form a⁽ⁿ⁾^{^{T}}\hat{x}ₗ+b⁽ⁿ⁾≤0. If a counter-example is found, then the transformational robustness property is disproven, and the counter-example returned at step 165b. If no counter-example is found, this means that the node pre-activation constraints introduced in the child verification problem were insufficient both to prove that the output constraints are satisfied and to reduce the search space for counter-examples in such a way that a counter-example can be found. Thus, further node pre-activation constraints can be introduced in the child verification problem by splitting the child verification problem into further child verification problems at step 166b.

At step 166b, the child verification problem is itself split into further child verification problems by performing steps 120-160 of method 100 are performed on the child verification problem. In particular, if the set of algebraic constraints comprised a constraint y_{(\hat{ƒ})}^{esip}(x₀,σ)≥0, where the upper bound y_{(\vec{ƒ})}^{esip}(x₀,σ) was formulated using auxiliary variables a, as explained with reference to step 162b, then further child verification problems obtained by introducing a node pre-activation constraint at any node n_{j,u} can be succinctly expressed by introducing the additional node pre-activation constraints

z_{j,u}(x₀,σ)=q_{j,u}(x₀)+Σ_{i,v}σᵥⁱϵ_{v,u}^{i,j}≤0

in the first further child verification problem and

z_{j,u}(x₀,σ)=q_{j,u}(x₀)+Σ_{i,v}σᵥⁱϵ_{v,u}^{i,j}≥0

in the second (complementary) further child verification problem, where the auxiliary variables σᵥⁱ are shared with the upper bound y_{(\hat{ƒ})}^{esip}(x₀,σ).

In this manner, tighter formulations of the node pre-activation constraints can be introduced in the child verification problems than would be possible if using a worst-case bound z_{j,u}^{(worst-case)}(x₀,σ)=q_{j,u}(x₀)+Σ_{i,v|ϵ}_{_{v,u}}_{^{i,j}}_{≥0}ϵ_{v,u}^{i,j}≤0 to formulate the node pre-activation constraint in the further child verification problem, thereby enabling further gains in efficacy.

We not that the succinctness of the novel node pre-activation constraints as presented above may have significantly improve the overall algorithms performance as they reduce the search space compared to previous linear approaches.

FIG. 11 shows an improved Symbolic Interval Propagation (SIP) process 1100 for obtaining lower and upper symbolic bounds [symbol] low_{l,k}(x₀) and [symbol] up_{l,k}(x₀) on the pre-activation \hat{x}_{i,u} of each node in terms of the network input x₀, comprising steps 1110-1190. Method 1100 first runs a Reverse Symbolic Interval Propagation (RSIP) process (e.g., as described with reference to FIG. 4) to compute lower and upper symbolic bounds [symbol] low_{i,u}^{rsip}(x₀) and [symbol] up_{i,u}^{rsip}(x₀) on the pre-activation \hat{x}_{i,u} of each node in the network, and then runs an Error-based Symbolic Interval Propagation (ESIP) process (e.g., as described with reference to FIG. 4) where the computed concrete lower and upper bounds on the pre-activation of each node, used to construct the linear relaxations of the activation function, are compared on-the-fly with bounds obtained from RSIP, resulting in a tighter relaxation than what can be obtained by ESIP or RSIP alone. The ESIP process thus returns a lower and an upper symbolic bound on the output \hat{x}ₗ of the network in terms of a linear function q_{l,k}(x₀) and a set of SIP approximation error terms ϵ_{v,k}^{i,l}, each measuring the contribution of the uncertainty introduced by approximating the activation function of node n_{i,v} into a lower and upper linear function bound to the total uncertainty at the k-th component of the output \hat{x}ᵢ, such that

q_{l,k}(\hat{x}₀)+Σ_{i,v|ϵ}_{_{v,k}}^{i,l}_{<0}ϵ_{v,k}^{i,l}≤\hat{x}_{l,k}≤q_{l,k}(x₀)+Σ_{i,v|ϵ}_{_{v,k}}_{^{i,l}}_{>0}ϵ_{v,k}^{i,l}

The method 1100 thus enables the advantages of RSIP and ESIP to be combined. First of all, using the tightest bounds of the two processes has compounding effects as the ESIP algorithm progresses through the network layer-by-layer, since the tightness of the relaxations of the activation functions in later layers depend on the tightness of the concrete bounds which can be obtained for the pre-activations of those layers, which depend on the tightness of the bounds on the activation functions in previous layers. In addition, method 1100 enables tighter bounds to be obtained than would be obtainable with either the ESIP or the RSIP algorithms on their own, since the better bound of the two is used to construct the linear relaxation of the activation function at each node. Finally, method 1100 combines the precision of the RSIP algorithm with the outputs of the ESIP algorithm in terms of the linear function q_{l,k}(x₀) and the error terms ϵ_{v,k}^{i,l}, which enable the direct and indirect effects of introducing a node pre-activation constraint on the outputs of the network to be computed with ease.

While it is expected that method 1100 may be used in step 161b of FIG. 10, method 1100 may also be used as a substitute for the method of FIG. 4 in step 130 of FIG. 1, and in steps 131a and 131b of FIGS. 6 and 8. The method 1100 may also be used in a stand-alone manner to compute bounds on the pre-activations of the network, and to obtain bounds on the output of the network.

At step 1100, a Reverse Symbolic Interval Propagation (RSIP) process is used to obtain lower and upper linear function bounds [symbol] low_{i,u}^{rsip}(x₀) and [symbol] up_{i,u}^{rsip}(x₀) on the pre-activation \hat{x}_{i,u} of each node in the network, e.g. as described with reference to FIG. 4.

At steps 1120-1190, an Error-based Symbolic Interval Propagation (ESIP) process is used to compute a lower and upper linear function bound on the output \hat{x}ₗ of the network. In particular, at each node, the better of the bounds obtained through the RSIP and ESIP processes is used to relax the activation function of the node.

Steps 1130-1160 may be performed for each layer in the network, starting from the first layer (step 1120). While some layers in the network have not yet been processed (step 1170), steps 1130-1160 may be repeated for each subsequent layer (step 1180), until all layers have been processed (step 1190).

Step 1130 can be performed in the same manner as step 420 of method 400, in the ESIP variant.

Step 1140 can be performed in the same manner as step 430 of method 400, in the ESIP variant, to obtain lower and upper concrete bounds \hat{l}_{j,u}^{esip} and û_{j,u}^{esip} on the pre-activation \hat{x}_{j,u} of node n_{j,u}.

Step 1150 can be performed substantially in the same manner as step 440 of method 400, in the ESIP variant. However, instead of just using the bounds \hat{l}_{j,u}^{esip} and û_{j,u}^{esip} to compute lower and upper linear function bounds on the pre-activation \hat{x}_{j,u} of node n_{j,u}, the bounds \hat{l}_{j,u}^{esip} and û_{j,u}^{esip} are compared to bounds obtained from the RSIP process,

$${\hat{l}}_{j , u}^{rsip} = {min}_{{x}_{0}} {low}_{i , u}^{rsip} ( {x}_{0} ) and {û}_{j , u}^{rsip} = {max}_{{x}_{0}} {up}_{i , u}^{rsip} ( {x}_{0} ) ,$$

and the tightest bounds used to construct the linear function bounds actlow_{j,u}(\hat{x}_{j,u}) and actup_{j,u}(\hat{x}_{j,u}).

The ESIP process then proceeds as normal, with step 1160 performed in the same manner as step 450 of method 400, in the ESIP variant.

FIG. 12 illustrates an example system capable of verifying the transformational robustness of a neural network. Such a system comprises at least one processor 1202, which may receive data from at least one input 1204 and provide data to at least one output 1206.

Results

The method of FIGS. 1 and 6 was implemented in a Python toolkit called DepBranch. DepBranch relies on Gurobi 9.2 for the MILP backend. The experimental comparisons focus on the leading and publicly available (at the time of submission) complete verification tools:
Eran (G. Singh, T. Gehr, M. Piischel, and P. Vechev. An abstract domain for certifying neural networks. Proceedings of the ACM on Programming Languages, 3(POPL):41, 2019.),
Venus (E. Botoeva, P. Kouvaros, J. Kronqvist, A. Lomuscio, and R. Misener. Efficient verification of neural networks via dependency analysis. In Proceedings of the 34th AAAI Conference on Artificial Intelligence (AAAI20). AAAI Press, 2020.),
Neurify (S. Wang, K. Pei, J. Whitehouse, J. Yang, and S. Jana. Efficient formal safety analysis of neural networks. In Proceedings of the 31st Annual Conference on Neural Information Processing Systems 2018 (NeurIPS18), pages 6369-6379, 2018.), and
Marabou (G. Katz, D. A. 407 Huang, D. Ibeling, K. Julian, C. Lazarus, R. Lim, P. Shah, S. Thakoor, H. Wu, A. Zeljic, D. L. Dill, M. J. Kochenderfer, and C. W. Barrett. The marabou framework for verification and analysis of deep neural networks. In Proceedings of the 31st International Conference on Computer Aided Verification (CAV19), pages 443-452, 2019.).

The results are evaluated on a number of widely used benchmarks in the context of the formal verification of neural networks—in particular, 3 MNIST models, a CIFAR10 model, and all 45 models comprising the ACAS XU system. The architecture of the networks is reported in Table 1. This provides a wide set of heterogeneous benchmarks, ranging from low to high dimensional inputs. The MNIST and CIFAR10 models were trained using the Adam 315 optimiser with a learning rate of 0.001. The local robustness of the MNIST and CIFAR10 models is verified for a challenging perturbation radius of 0.05 against the first 100 correctly classified images from each dataset. The ACAS XU models are verified against the set of safety specifications set out in G. Katz, C. W. Barrett, D. L. Dill, K. Julian, and M. J. Kochenderfer. Reluplex: An efficient SMT solver for verifying deep neural networks. In Proceedings of the 29th International Conference on Computer Aided Verification (CAV17), volume 10426 of Lecture Notes in Computer Science, pages 97-117. Springer, 2017.; each specification concerns a subset of the models for a total of 172 verification problems.

All experiments were carried out on an Intel Core i7-7700K (4 cores) equipped with 16 GB RAM, running Linux kernel 4.15. DepBranch was run on two threads with the branching depth set to 4 and the MILP node threshold set to 10000 for the ACAS and MNIST models and to 300 for the CIFAR10 model. DepBranch used both symbolic and non-symbolic dependencies for the ACAS XU and MNIST models and only non-symbolic ones for the CIFAR10 model. Eran was run using the deepzono domain and with the complete parameter set to true; the tool was not run for ACAS XU since it supports only one of the ACAS XU safety specifications. Neurify was run with MAX_THREAD set to 2 for ACAS XU and 1 for MNIST and CIFAR10; for the verification problems where Neurify raised a segmentation fault (because of excessive memory consumption) it was considered as timing out. Marabou was run with the parameters reported in G. Katz, D. A. 407 Huang, D. Ibeling, K. Julian, C. Lazarus, R. Lim, P. Shah, S. Thakoor, H. Wu, A. Zeljic, D. L. Dill, M. J. Kochenderfer, and C. W. Barrett. The marabou framework for verification and analysis of deep neural networks. In Proceedings of the 31st International Conference on Computer Aided Verification (CAV19), pages 443-452, 2019. Each verification problem was run for a timeout of one hour.

Table 1 below provides those results. The ver columns report the number of verification problems that each tool was able to solve; the t columns give the average time in seconds taken by each tool; the ip columns show the improvement percentage of DepBranch over each tool.

TABLE 1
Experimental results for the method of FIGS. 1 and 6.

| | | DepBranch | | Eran [25] | | | Venus [4] | | |
|---|---|---|---|---|---|---|---|---|---|
| Model | Architecture | ver | t | ver | t | ip | ver | t | ip |
| ACAS XU | 784, 6 × 50, 10 | 171 | 114 | — | — | — | 170 | 115 | 0.9 |
| MNIST1 | 784, 2 × 512, 10 | 100 | 25 | 85 | 844 | 3570 | 100 | 59 | 136 |
| MNIST2 | 784, 2 × 768, 10 | 100 | 17 | 81 | 1094 | 6335 | 99 | 85 | 400 |
| MNIST3 | 784, 2 × 1024, 10 | 99 | 85 | 68 | 1882 | 2114 | 97 | 203 | 139 |
| CIFAR10 | 3072, 1024, | 100 | 114 | 5 | 3031 | 2559 | 94 | 465 | 308 |
| | 2 × 512, 10 | | | | | | | | |

| | | Neurify [28] | | | Marabou [16] | | |
|---|---|---|---|---|---|---|---|
| Model | Architecture | ver | t | ip | ver | t | ip |
| ACAS XU | 784, 6 × 50, 10 | 167 | 137 | 20 | 165 | 365 | 220 |
| MNIST1 | 784, 2 × 512, 10 | 52 | 3253 | 12912 | 0 | 3600 | 14300 |
| MNIST2 | 784, 2 × 768, 10 | 57 | 2652 | 15500 | 0 | 3600 | 21076 |
| MNIST3 | 784, 2 × 1024, 10 | 59 | 2440 | 2771 | 0 | 3600 | 4135 |
| CIFAR10 | 3072, 1024, | 79 | 912 | 700 | 0 | 3600 | 3057 |
| | 2 × 512, 10 | | | | | | |

The method of FIGS. 1 and 8, and using the improved SIP process of FIG. 11, was implemented in a Python toolkit called DeepSplit. DeepSplit takes as input a transformational robustness verification problem and outputs Safe, Unsafe or Undetermined depending on the circumstances. The toolkit may also output Underflow if the solution can not be found due to floating-point precision. DeepSplit utilises NumPy 1.18.2 and Numba 0.47.0 to implement ESIP, RSIP and for computing the direct and indirect effect of introducing a node pre-activation constraint. The global search phase is handled with the python interface of the Xpress LP solver version 35.01.03 and the gradient descent-based local search is implemented with PyTorch 1.4.0. Finally, the branch and bound phase is parallelised with Python's multiprocessing module.

The performance of DeepSplit was evaluated on a variety of networks against Venus and Marabou, as well as:
VeriNet (P. Henriksen and A. Lomuscio. Efficient neural network verification via adaptive refinement and adversarial search. In Proceedings of the 24th European Conference on Artificial Intelligence (ECAI20), 2020.) and
ReluVal (S. Wang, K. Pei, J. Whitehouse, J. Yang, and S. Jana. Formal security analysis of neural networks using symbolic intervals. In Proceedings of the 27th USENIX Security Symposium (USENIX18), 2018).

Venus, Marabou and VeriNet were used for benchmarking with networks trained on the MNIST dataset as these toolkits have SoA performance for high-dimensional input networks. A much larger convolutional network trained on the CIFAR-10 dataset was also used; however, Venus and Marabou do not support convolutional networks, so only VeriNet was used for comparison. For the ACAS Xu networks, benchmarks were performed against Venus, Marabou and ReluVal. All benchmarks were performed on a workstation with an Intel Core i9 9900X 3.5 GHz 10-core CPU, 128 GB Ram and Fedora 30 with Linux kernel 5.3.6; the results are summarised in Table 1. The times include all cases verified in at least one of the toolkits within a 7200 second timeout for the ACAS benchmarks and 1800 seconds for the rest.

The MNIST benchmarks were performed on three networks with 2, 4 and 6 fully connected layers and 256 ReLU nodes in each layer. For each network local transformational robustness was verified with l_{∞}≤ϵ perturbations for ϵ∈{0.01; 0.02; 0.03; 0.05; 0.07} and 50 images. In the experiments DeepSplit had significantly fewer timeouts and a speed-up of around one order of magnitude over other toolkits; the only exception was the two-layer network where VENUS was faster for safe cases. As DEEPSPLIT has fewer timeouts than the other toolkits, we expect the real speed up to be larger than shown here.

The CIFAR-10 benchmarks used a convolutional network with six layers and a total of 109632 ReLU nodes. Like the MNIST benchmarks, l_{∞}-bounded local robustness was verified, but with the smaller perturbations ϵ∈{0.0005; 0.001; 0.003; 0.005} as the CIFAR network was less robust. DEEPSPLIT solved all cases solved by VERINET; so the reported 5 times speed-up is a lower bound.

The ACAS Xu benchmarks were performed on the ACAS Xu networks commonly used to benchmark verification toolkits. The same properties were verified as in G. Katz, C. W. Barrett, D. L. Dill, K. Julian, and M. J. Kochenderfer. Reluplex: An efficient SMT solver for verifying deep neural networks. In Proceedings of the 29th International Conference on Computer Aided Verification (CAV17), volume 10426 of Lecture Notes in Computer Science, pages 97-117. Springer, 2017., except that all 45 networks were used for properties 1-4, instead of a subset. The ACAS networks only have six inputs, significantly fewer than the previous networks (784 for MNIST and 3072 for CIFAR-10). The experiments indicate that input-splitting is essential for low-dimensional networks, so input-splitting was enabled for DEEPSPLIT. DEEPSPLIT was still the only tool able to verify all ACAS properties within the timeout, and achieved a speed-up of 25-100 times.

Table 2 below provides these results. Columns nₛ, nᵤ and nₜ report the number of cases that resulted in safe, unsafe and timeout, respectively. Columns tₐ, tₛ and tᵤ report the times used for all, safe and unsafe cases, respectively.

TABLE 2
Experimental results for the method of FIGS. 1 and 8.

| | | nₛ | nᵤ | nₜ | tₐ (s) | tₛ (s) | tᵤ (s) |
|---|---|---|---|---|---|---|---|
| MNIST | DEEPSPLIT | 119 | 131 | 0 | 2046 | 2037 | 9 |
| 256 × 2 | VENUS | 119 | 131 | 0 | 723 | 149 | 574 |
| | VERINET | 102 | 130 | 18 | 33904 | 32098 | 1805 |
| | MARABOU | 108 | 19 | 123 | 251846 | 35285 | 216560 |
| MNIST | DEEPSPLIT | 119 | 66 | 65 | 2669 | 2634 | 35 |
| 256 × 4 | VENUS | 110 | 30 | 110 | 92901 | 22674 | 70227 |
| | VERINET | 101 | 66 | 83 | 36283 | 35439 | 845 |
| | MARABOU | 84 | 0 | 166 | 215730 | 96930 | 118800 |
| MNIST | DEEPSPLIT | 100 | 76 | 74 | 6853 | 1441 | 5430 |
| 256 × 6 | VENUS | 54 | 23 | 173 | 195334 | 91545 | 103788 |
| | VERINET | 81 | 72 | 97 | 48840 | 34231 | 14609 |
| | MARABOU | 35 | 0 | 215 | 293108 | 150908 | 142200 |
| CIFAR | DEEPSPLIT | 76 | 47 | 77 | 3174 | 1977 | 1198 |
| | VERINET | 69 | 47 | 84 | 15886 | 13925 | 1934 |
| AXAS | DEEPSPLIT | 140 | 47 | 0 | 831 | 784 | 47 |
| | RELUVAL | 140 | 45 | 2* | 20971 | 4318 | 16653 |
| | VENUS | 139 | 46 | 2 | 62749 | 54347 | 8402 |
| | MARABOU | 135 | 45 | 7 | 113265 | 97183 | 16082 |

1. A computer-implemented method for verifying the transformational robustness of a neural network, comprising the steps of:
obtaining data representing a trained neural network, a set of algebraic constraints on the output of the network, and a range of inputs to the neural network over which the algebraic constraints are to be verified, such that the data defines a transformational robustness verification problem;
determining a set of complementary constraints on the pre-activation of a node in the network such that for any input in the range of inputs, at least one of the complementary constraints is satisfied;
generating a plurality of child verification problems based on the transformational robustness verification problem and the set of complementary constraints;
determining, for each child verification problem, whether a counter-example to the child verification problem exists; and
based on the determination of whether counter-examples to the child verification problems exist, determining whether the neural network is transformationally robust.

2. A method according to claim 1, wherein at least two constraints of the complementary constraints constrain the pre-activation of the node to be respectively less than and greater than a threshold pre-activation value at which the activation function of the node has a breakpoint.

3. A method according to claim 1, wherein the neural network comprises one or more nodes which apply a Rectified Linear Unit (ReLU) activation function, and wherein the complementary constraints are constraints on the pre-activation of a ReLU node.

4. A method according to claim 1, wherein determining the set of complementary constraints on the pre-activation of a node in the network comprises:
estimating, for each of a plurality of candidate node pre-activation constraints, a reduction in complexity of the transformational robustness verification problem occasioned by introducing the constraint; and
selecting, based on the estimated reductions in complexity, a set of two or more complementary constraints.

5. A method according to claim 4, wherein estimating, for a candidate node pre-activation constraint, a reduction in complexity of the transformational robustness verification problem occasioned by introducing the constraint comprises:
estimating a reduction in the estimated ranges of the pre-activations of other nodes occasioned by introducing the candidate node pre-activation constraint; and
estimating, based on the estimated reductions in estimated ranges of pre-activations of other nodes, an estimated reduction in complexity of the transformational robustness verification problem.

6. A method according to claim 5, wherein estimating, for a candidate node pre-activation constraint, a reduction in the estimated ranges of the pre-activations of other nodes occasioned by introducing the candidate node pre-activation constraint, comprises:
determining, for each node in the network, a symbolic expression in terms of the input to the neural network that is a lower bound to the pre-activation of the node, and a symbolic expression in terms of the input to the neural network that is an upper bound to the pre-activation of the node; and
estimating the reduction in the estimated ranges of the pre-activations of other nodes based on the lower and upper symbolic bounds.

7. A method according to claim 6, wherein the lower and the upper symbolic bounds are both linear functions of the input to the neural network, and wherein determining the lower and upper symbolic bounds comprises performing a Symbolic Interval Propagation.

8. A method according to claim 6, wherein determining, for each child verification problem, whether a counter-example to the child verification problem exists comprises encoding the child verification problem as a set of algebraic constraints and solving for a solution to the set of algebraic constraints using a branch-and-bound algorithm.

9. A method according to claim 8, wherein estimating, based on the estimated reductions in estimated ranges of pre-activations of other nodes, an estimated reduction in complexity of the transformational robustness verification problem occasioned by introducing a candidate node pre-activation constraint comprises:
determining a number of nodes whose pre-activations would be constrained to be fully positive or fully negative over the entire range of inputs to the network were the candidate node pre-activation constraint to be introduced.

10. A method according to claim 6, wherein determining, for each child verification problem, whether a counter-example to the child verification problem exists comprises:
determining, for each node in the network, a symbolic expression in terms of the input to the neural network that is a lower bound to the pre-activation of the node, and a symbolic expression in terms of the input to the neural network that is an upper bound to the pre-activation of the node;
determining, based on the lower and upper symbolic bounds, a lower and an upper bound for each component of the output of the network; and
determining, based on the lower and upper bounds, whether a counter-example to the child verification problem exists.

11. A method according to claim 10, wherein estimating, based on the estimated reductions in estimated ranges of pre-activations of other nodes, an estimated reduction in complexity of the transformational robustness verification problem occasioned by introducing a candidate node pre-activation constraint comprises:
determining an estimated improvement in the lower and upper bounds for each component of the output of the network were the candidate node pre-activation constraint to be introduced.

12. A method according to claim 1, wherein the neural network is an image processing neural network which takes an image as input.

13. A method according to claim 1, wherein the neural network is a controller neural network for controlling a physical device.

14. A computer program product comprising computer executable instructions which, when executed by one or more processors, cause the one or more processors to carry out the method of claim 1.

15. A perception system comprising one or more processors configured to carry out the method of claim 1.
